(19) United States
(12) Patent Application Publication
(10) Pub. No.: US 2026/0140801 A1
(43) Pub. Date: May 21, 2026

(54) CONVERSANT ORGANIZATION AND MANAGEMENT FOR INTERNET SERVICES

(71) Applicant: NAMECHEAP, INC., Phoenix, AZ (US)

(72) Inventors: Yevhenii MOROZ, Matosinhos (PT); Artem ZAKHARCHENKO, Vila Nova de Gaia (PT); Sergii SMIRNOV, Perafita (PT); Rui Rodrigo Cabral Pacheco DE MELO, Maia (PT)

(73) Assignee: NAMECHEAP, INC., Phoenix, AZ (US)

(21) Appl. No.: 19/388,946

(22) Filed: Nov. 13, 2025

Related U.S. Application Data
(60) Provisional application No. 63/721,417, filed on Nov. 15, 2024.

(51) Int. Cl. G06F 9/54; G06F 9/50; H04L 61/4511

(52) U.S. Cl. CPC G06F 9/547; G06F 9/5055; H04L 61/4511

(57) ABSTRACT

The technology disclosed relates to systems and methods for artificial intelligence (AI) assisted management of web services. Disclosed implementations can include receiving, at a user interface, a user input including unstructured natural language and sending an HTTP request including the user input via an API layer to a conversation logic. The technology disclosed can further include pre-processing the HTTP request using the conversation logic, wherein the pre-processing further includes one or more of: parsing the unstructured dialogue of the user input, filtering out filler words from the user input, labelling the user input, feature selecting, feature augmenting, and appending metadata to the HTTP request, and identifying a web service management task responsive to the pre-processed HTTP request. The identified web service management task can be routed to a best fit AI model trained to perform one or more web service management tasks.

### CROSS-REFERENCE

This application claims the benefit of U.S. Provisional Ser. No. 63/721,417 filed on 15 Nov. 2024. The priority application is hereby incorporated by reference herein for all purposes.

### RELATED APPLICATION(S)

This application is related to the following commonly owned applications: U.S. patent application Ser. No. 18/747,324 titled “SECURE ONLINE ID VALIDATION AND REVIEW SYSTEM,” filed 18 Jun. 2024 (Atty Docket No. NMCP 1000-3), which is a Continuation of U.S. patent application Ser. No. 17/366,970 titled “SECURE ONLINE ID VALIDATION AND REVIEW SYSTEM,” filed 2 Jul. 2021 (Atty Docket No. NMCP 1000-2), now U.S. Pat. No. 12,015,610, which is a Continuation of U.S. patent application Ser. No. 16/443,746 titled “SECURE ONLINE ID VALIDATION AND REVIEW SYSTEM,” filed 17 Jun. 2019 (Atty Docket No. NMCP 1000-1), now U.S. Pat. No. 11,057,380;

U.S. patent application Ser. No. 19/031,359, titled “SYSTEMS AND METHODS FOR DETECTING CONFLICTS IN INTERNET SERVICES”, filed 18 Jan. 2025 (Atty Docket No. NMCP 1001-11), which is a continuation of U.S. patent application Ser. No. 18/525,547, titled “SYSTEMS AND METHODS FOR DETECTING CONFLICTS IN INTERNET SERVICES”, filed 30 Nov. 2023 (Atty Docket No. NMCP 1001-9), now U.S. Pat. No. 12,267,292, which is a continuation of U.S. patent application Ser. No. 17/875,824, titled “SYSTEMS AND METHODS FOR DETECTING CONFLICTS IN INTERNET SERVICES”, filed 28 Jul. 2022 (Atty Docket No. NMCP 1001-7), now U.S. Pat. No. 11,838,260, which is a continuation of U.S. patent application Ser. No. 17/344,824 titled “SYSTEMS AND METHODS FOR DETECTING CONFLICTS IN INTERNET SERVICES,” filed on 10 Jun. 2021 (Atty Docket No. NMCP 1001-3), now U.S. Pat. No. 11,438,304, which is a Continuation of U.S. patent application Ser. No. 16/823,265 titled “SYSTEMS AND METHODS FOR DETECTING CONFLICTS IN INTERNET SERVICES,” filed on 18 Mar. 2020 (Atty Docket No. NMCP 1001-1), now U.S. Pat. No. 11,038,839;

U.S. patent application Ser. No. 19/224,489, titled “SYSTEMS AND METHODS FOR RESOLVING CONFLICTS IN INTERNET SERVICES”, filed 30 May 2025 (Atty Docket No. NMCP 1001-15), which is a continuation of U.S. patent application Ser. No. 18/540,742, titled “SYSTEMS AND METHODS FOR RESOLVING CONFLICTS IN INTERNET SERVICES”, filed 14 Dec. 2023 (Atty Docket No. NMCP 1001-10), now U.S. Pat. No. 12,323,383, which is a continuation of U.S. patent application Ser. No. 17/872,891, titled “SYSTEMS AND METHODS FOR RESOLVING CONFLICTS IN INTERNET SERVICES”, filed 25 Jul. 2022 (Atty Docket No. NMCP 1001-6), now U.S. Pat. No. 11,848,908, which is a continuation of U.S. patent application Ser. No. 17/344,832, titled “SYSTEMS AND METHODS FOR RESOLVING CONFLICTS IN INTERNET SERVICES”, filed 10 Jun. 2021 (Atty Docket No. NMCP 1001-4), now U.S. Pat. No. 11,399,008, which is a continuation of U.S. patent application Ser. No. 16/823,267 titled “SYSTEMS AND METHODS FOR RESOLVING CONFLICTS IN INTERNET SERVICES,” filed on 18 Mar. 2020 (Atty Docket No. NMCP 1001-2), now U.S. Pat. No. 11,038,840; and

U.S. patent application Ser. No. 19/031,288, titled “DOMAIN COMMUNICATION SYSTEM”, filed 17 Jan. 2025 (Atty Docket No. NMCP 1002-7), which is a continuation of U.S. Application No. Ser. No. 17/990,622 titled “DOMAIN COMMUNICATION SYSTEM”, filed 18 Nov. 2022 (Atty Docket No. NMCP 1002-2), now U.S. Pat. No. 12,212,628, which claims the benefit of U.S. Provisional Ser. No. 63/282,054 , filed on 22 Nov. 2021 (Attorney Docket No. NMCP 1002-1);

U.S. patent application Ser. No. 18/389,692, titled “SYSTEM AND METHODS FOR DIGITALLY UNBOXING INTERNET SERVICES”, filed 16 Dec. 2023 (Atty Docket No. 1003-1) which is a Continuation-in-Part of U.S. patent application Ser. No. 18/540,742, titled “SYSTEMS AND METHODS FOR RESOLVING CONFLICTS IN INTERNET SERVICES”, filed Dec. 14, 2023 (Attorney Docket No. NMCP 1001-10), now U.S. Pat. No. 12,323,383, and a Continuation-in-Part of U.S. patent application Ser. No. 18/525,547, titled “SYSTEMS AND METHODS FOR DETECTING CONFLICTS IN INTERNET SERVICES”, filed 30 Nov. 2023 (Atty Docket No. NMCP 1001-9), now U.S. Pat. No. 12,267,292; and

U.S. Provisional Ser. No. 63/753,415 , titled “SYSTEM AND METHODS FOR LOCATION-BASED AND ORBIT-BASED DNS SERVICES”, filed 3 Feb. 2025 (Atty Docket No. NMCP 1005-1).

The related application(s) are hereby incorporated by reference herein for all purposes.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF INVENTION

The technology disclosed relates generally to domain name systems (DNS), and in particular relates to optimizing navigation and management of internet services using an artificial intelligence-based system and agentic interface for facilitating interactions between a client, a domain registrar, and a server hosting web services, including domains, DNS, hosting, electronic communications, e-commerce flows, and so on.

### BACKGROUND

The technology disclosed relates to artificial intelligence (AI)-based management of internet services. In particular, it relates to AI systems and methods that process user inputs, generate and route HTTP requests through layered architecture, and employ conversation logic to interpret user intent and direct tasks to appropriate agents or trained machine learning models. The technology disclosed also relates to optimizing routing and processing through integration with additional web service tools, such as DNS setup, domain registration, and identity management, as well as leveraging large language models (LLMs) to refine inputs, augment data, and improve the quality and consistency of AI-generated responses.

An opportunity arises to develop AI-driven interfaces and frameworks for managing web services. Better-integrated, more adaptive, and more resource-efficient solutions may result, including systems and methods capable of dynamically balancing accuracy and generalization while enhancing transparency, responsiveness, and user experience in AI-based service management.

### SUMMARY

The technology disclosed relates to an artificial intelligence (AI)-based system and methods for management of internet services. The disclosed AI system includes a user interface that processes a user input, initiates an HTTP request in response to the processed user input, and forwards the HTTP request (including the user input) to an API layer. The API layer receives the request and routes it to a conversation logic that is configured to parse dialogue and process user queries. The conversation logic processes language-related tasks and interprets user inputs to identify a goal or task necessary to respond to the user input. The conversation logic routes the request to an execution layer of agents that can include one or more agents of a configuration or type of: (i) an appropriate agent configured through custom prompts to guide agent behavior to perform tasks that match the particular task identified by the conversation logic within available LLMs, and/or (ii) an appropriate trained machine learning model out of a plurality of available trained machine learning models, wherein the appropriate trained machine learning model is the machine learning model that has been trained to perform tasks that match the particular task identified by the conversation logic more closely than the other models of the plurality of trained machine learning models.

In one non-limiting example for teaching purposes, the plurality of trained machine learning models may include a first model trained to generate suggested domain names in response to user-defined criteria; a second model trained to determine current pricing for domain names based on availability, a valuation schema based on features of the domain name (e.g., length, category of domain extension, etc.), and demand sensing; a third model trained to automate SSL/TSL security tasks; a fourth model trained to process and summarize electronic communications; and one or more additional trained machine learning models. If the conversation logic classifies a first user input as a domain name design-related input, the first user input will be routed to the domain name generation model. If the conversation logic classifies a second user input as a domain name purchase-related input, the second user input will be routed to the domain name pricing model.

In many implementations, the conversation logic interacts with additional web service tools, via the server, for data processing and other auxiliary functions that augment the input processing and routing with additional information to improve accuracy. Web service tools available for interaction with the conversation logic can include, for example, a DNS set-up logic, an electronic communications logic (e.g., an email service), a subscription management logic, a domain registrar, an API manager, a web design service, an identity and access management service (e.g., authentication and authorization tools), a web security manager, and so on. In some implementations, the conversation logic also sends the HTTP request to a trained large language model (LLM) to refine the user input and perform additional feature engineering tasks to improve the quality of the user input with natural language processing, fine-tuning, and data labelling tasks. For example, the LLM may append augmentation data to the HTTP request including additional context, metadata, or classification labelling to enhance the input quality in order to subsequently influence the downstream output quality from the trained machine learning model.

Once the HTTP request has been passed to the trained machine learning model (optionally including augmentation data from an LLM in some implementations) and the trained machine learning model has generated an output in response to the request, the output is sent to the API layer, which subsequently forwards the output to a response formatting logic. The response formatting logic formats and structures the request for consistency and readability. The formatted response is sent back to the user interface and displayed via a graphical display to the user. In some implementations, the user can provide additional feedback inputs to refine the output, or provide additional subsequent inputs wherein the AI system stores the conversation history in an accessible cache that is processed along with future inputs such that all available information is used to perform the AI-assisted operations.

The technology disclosed provides a solution to the problem of composing a useful graphical user interface (GUI), responsive to a user input relating to web services setup and management, by leveraging additional refinement and routing tools that optimize the quality and relevance of the AI-generated output provided to the user in response to an input. A method implementation of the technology disclosed includes invoking at least one callback function that prompts at least one trained AI, including a large language model (LLM) running on specialized array processing hardware, to initiate an API request in response to a received user input, route the request to a particular configured agent or trained AI model in dependence upon a match between the received user input and a task that the particular configured agent or trained AI model is trained (or configured) to perform. The requests are dynamically adjusted with additional metadata based on prior user input and data pre-processing operations, such as feature engineering. Other implementations of the technology disclosed leverage voice-based interaction in addition to, or in place of, text-based communication. For the sake of clarity and conciseness, the example implementations described will primarily refer to text-based communication, but it is understood that voice-based communication can be implemented as an alternative to written queries and responses. The method also includes further prompting one or more configured agents or trained AI models to autonomously engage with other interconnected web service tools and leverage said tools in order to perform tasks responsive to a user input. In addition to the interconnected web service tools, the internet, private libraries and other proprietary collections can be searched.

Particular aspects of the technology disclosed are described in the claims, specification and drawings.

### BRIEF DESCRIPTION OF THE DRAWINGS

FIG. 1 is a high-level block diagram including an AI-based web service management system, according to one example implementation of the technology disclosed.

FIG. 2A is a flow diagram of an AI-based workflow for managing web services, according to one example implementation of the technology disclosed.

FIG. 2B is a block diagram illustrating a workflow involving the AI-based web service management system of FIG. 1, according to one example implementation of the technology disclosed.

FIG. 3A is a message flow diagram relating to AI-assisted web domain generation.

FIG. 3B illustrates an example implementation involving the matching of a pre-processed request to a particular trained AI model from a distributed network ensemble including a plurality of respective AI models trained for respective tasks in web services management.

FIG. 3C illustrates another example implementation involving the matching of a pre-processed request to particular trained AI models from a distributed network ensemble including a plurality of respective AI models trained for respective tasks in web services management.

FIG. 3D illustrates an example implementation involving the routing of a pre-processed request to particular trained AI models from a distributed network ensemble including a plurality of respective AI models trained for respective tasks in web services management.

FIG. 3E illustrates another example implementation involving the routing of a pre-processed request to particular trained AI models from a distributed network ensemble including a plurality of respective AI models trained for respective tasks in web services management.

FIG. 4A is a flow diagram for an example user interaction with the disclosed conversational user interface, according to some implementations.

FIG. 4B is a flow diagram for another example user interaction with the disclosed conversational user interface, according to other implementations.

FIG. 4C is an example configuration prompt for an AI agent capable of facilitating user interaction with the disclosed conversational user interface.

FIG. 5 is a simplified block diagram of an example computer system that can be used to implement the AI-based web service management system of FIG. 1.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

As digital ecosystems expand, the complexity of managing interconnected web services has grown exponentially. Businesses and individual users alike depend on rapid, secure, and accurate orchestration of internet and cloud services, yet existing management tools remain fragmented and error-prone. Modern internet infrastructure is increasingly reliant on precise coordination sophisticated service ecosystems, and the unprecedented growth of online infrastructure has outpaced the efficiency of existing management systems. Web service management often involve redundant operations, manual oversight, and slow data propagation across incompatible systems. Furthermore, the modern digital era necessitates secure management of online identity data, domains, and communications. Convergence of artificial intelligence (AI) with existing digital ecosystems can present a transformative opportunity to reimagine how these services are controlled, maintained, and allocated. Existing large language models (LLMs) and agentic AI systems have demonstrated potential, but these models remain heavily dependent on user instruction and supervision such that the performance of the AI agent and/or quality of the task output are based primarily on the skill and effort of the user. As a result, the functional role of the agentic AI system is limited and these tools have limited real-world practicality.

These technological limitations are particularly evident in the realm of web services management, as illustrated by conventional web service management interfaces. Said interfaces often require users to manually navigate between disconnected domain registrars, DNS providers, e-commerce tools, and security platforms, each with distinct interfaces and data schemas. These disjointed systems not only increase user cognitive load and data redundancy, but also heighten the likelihood of configuration errors, service downtime, and security vulnerabilities. The complexity is amplified when user interactions rely on static rule-based scripts or generic natural language systems incapable of accurately interpreting unstructured or variably phrased inputs. Consequently, traditional systems lack the adaptability required to interpret user goals dynamically, orchestrate multiple interconnected subsystems, and execute service management tasks reliably across heterogeneous environments.

The technology disclosed provides a technical solution to these challenges through an AI-based management system that integrates a conversation logic, an API routing layer, and a distributed network ensemble of specialized trained AI models operating on dedicated array processing hardware. Disclosed systems can automatically interpret unstructured natural language or voice-based user inputs, pre-process inputs via linguistic and feature engineering techniques, identify a web service management task based on the inputs, select one or more particular trained AI model(s) within the distributed network ensemble associated with the identified web service management task, and dynamically route requests to at least one trained AI model of the one or more selected trained AI model(s) within the distributed network ensemble. By incorporating input format standardization, similarity metric-based task matching, and cross-model coordination, the disclosed technology transforms previously brittle text-processing operations into robust, contextually-enriched system-level interactions. This structured processing pipeline enables consistent and accurate task performance that cannot be achieved through manual human input or generic computing mechanisms.

Unlike overgeneralized conversational models or simple command interpreters, the disclosed system can coordinate specific interrelated computer operations, thereby improving the functionality of said operations. Input normalization and ensemble orchestration operations executed on specialized array hardware enables the disclosed systems and methods to optimize resource allocation, reduce response latency, improve performance accuracy, and enhance the relevance of generated outputs. These technical improvements stem from the system architecture-level refinements that modify how the underlying computing hardware processes and prioritizes data, such as reduced search space computation, optimized similarity metric calculations, and input routing within the distributed network ensemble of trained AI models.

The technology disclosed also addresses a longstanding problem in natural language systems: brittleness to linguistic variations. Agentic AI systems are functionally limited by the underlying model capacity to interpret user inputs, and this goal is challenging given the variability in user prompt clarity, specificity, syntax, and linguistic mannerisms. Speech inputs are more difficult, introducing additional complexities related to a user's unique speech pattern, such as their tone, pitch, inflection, cadence, accent, dialect, and so on. For example, if multiple users seek to prompt the same trained AI agent to perform an identical task, the resulting outputs corresponding to different users will diverge to varying degrees based on each user's conversational idiosyncrasies. Many implementations of the technology disclosed include a conversation logic layer that introduces a novel preprocessing pipeline that filters non-predictive filler terms, identifies lexemes, standardizes prompt structure, and appends metadata to align user inputs with a pre-defined input structure associated with a trained AI model. This structured data transformation improves compatibility between diverse language inputs and model-specific formatting requirements, leading to enhanced downstream inference accuracy. Consequently, the conversation logic optimizes computational throughput by minimizing model confounding during inference and promoting reliable consistency in model behavior. In many implementations, input standardization and dynamic adjustment of model routing enables stable, high-performance AI-based systems that are resilient to unstructured and/or noisy user inputs.

In another aspect of the technology disclosed, the AI-based system can leverage multi-model ensemble coordination within a distributed network ensemble of AI models to streamline input processing for a broader range of task applicability without sacrificing specificity. Training processes for AI systems often exhibit a tradeoff between breadth and precision, in that generalized models can handle diverse tasks at the expense of accuracy, whereas specialized models can perform with higher accuracy at the expense of versatility. In many implementations, the disclosed ensemble-based architecture can dynamically select between various trained AI models within a network of multiple AI models that differ in learned knowledge, trained tasks, and degree of specialization. In one example implementation, a disclosed method includes selecting an AI model to process data from a user input based on a computed similarity metric that quantifies the semantic distance between an identified user task and a known training domain of respective AI models within a distributed network ensemble. This routing mechanism can minimize computational waste, prevent unnecessary inference calls, improve processor utilization, and reduce latency. Hence, the technology disclosed can leverage real-time (or near real-time, e.g., based on a pre-defined time threshold such as one second, three seconds, five seconds, ten seconds, thirty seconds, one minute, three minutes, five minutes, or any other value within an inclusive range bound by any two of these values) adaptive model orchestration in distributed network ensemble AI systems, enabling the AI system to perform complex, multi-domain operations that would otherwise be infeasible at commercial scale using existing tools.

In another aspect, the disclosed hybrid conversational user interface (“CUI”) contributes to improved user accessibility and system practicality. By combining natural language processing (NLP) with predictive UI element surfacing, the CUI can dynamically generate graphical elements, such as lists, filters, and buttons, based on a detected user intent and/or the path of a user interaction as the interaction progresses. The integration of the disclosed CUI with the AI-based management system allows for context-sensitive presentation of actionable elements, improving data flow efficiency and reducing the frequency of required client-server communication. Said user interface optimizations improve how the client device renders, retrieves, and updates content, reducing processing overhead and bandwidth usage. The resulting workflow enabled by the CUI not only enhances user experience, but also constitutes an important improvement to user interface functionality and input-output performance.

In many implementations of the technology disclosed, the AI-based web management system can leverage callback functions and autonomous interactions between AI agents and external web service APIs to achieve end-to-end automation of complex tasks such as domain registration, DNS updates, SSL/TSL configuration, and e-commerce transactions. These interactions are executed programmatically and securely, improving both operational accuracy and cybersecurity.

User-facing AI agent services can be trained for generalized learning in order to handle a wide variety of user queries, or alternatively, can be trained for a narrow, specialized category of tasks. However, effective deployment of AI models that have been trained at either extreme (e.g., a general knowledge AI agent versus a narrow-purpose AI agent) is difficult to achieve. Generalization of AI learning to a broader range of knowledge and task automation is often inversely correlated with accuracy of the trained AI model. The problem of maintaining accuracy as the generality of an AI model increases can be attributed to many root causes. One of these root problems is the need for sufficient training data. Real world AI models are typically trained on hundreds of thousands to millions of training examples in order to achieve the accuracy required for quality performance during production. As the overall purpose of the model expands, so does the volume of training data required to achieve sufficiently accurate performance (as defined on a task-by-task basis, e.g., an accuracy rate of 90% may be sufficient for an entertainment-purpose chatbot, but insufficient for an autonomous vehicle). Moreover, imbalances or biases within the training data are also detrimental to model accuracy. Another related root cause for the challenge of balancing model breadth and model accuracy is computational cost. In order to perform complex tasks, such as responding to a broader range of user queries, the size and complexity of the AI architecture must also increase to support the increased burden. Even in a hypothetical scenario involving a large, sophisticated AI model with access to an adequately large volume of high quality training data, such a scenario is accompanied by extremely high computational power demands. Consequently, the accuracy of broad-purpose AI is limited by the aforementioned prohibitive resource demands associated with expanding model complexity (e.g., data volume, computational resources, time, financial cost).

In contrast, highly specialized AI operations can be executed for many tasks without the above-mentioned drawbacks of general purpose models. As the intended task or purpose of the model narrows, however, the rigidity of the model increases during production mode. The specialized trained AI model can have very poor accuracy, or fail to address the query entirely, when facing a production query that does not closely align with the training examples. In addition to the type of query, the format in which the query is presented can also be restricted for a specialized AI. For example, a model can be trained to perform a particular task but fail to identify the task when an input query is not phrased in a similar manner as previously seen during training. During production, different users may attempt to initiate the same task with differing language or phrasing. If an AI model is ill-equipped for flexible input processing, this is significant hindrance to the utility of the model.

The technology disclosed presents an innovative solution to the aforementioned problems by providing a hybridized model characterized by the advantages of both generalized and specialized AI, without the disadvantages described above. In an embodiment and by way of example, one or more agents can be configured through custom prompts, enabling zero-shot training capabilities by customizing prompts to guide agent behavior within available LLMs. Another implementation of the technology disclosed leverages an ensemble of specialized AI models, thereby achieving a broad-purpose tool with the accuracy offered by specialization. In one nonlimiting example, the disclosed system is connected to a plurality of trained AI models, including at least a trained web domain AI agent, a trained e-commerce AI agent, and a trained communication management AI agent. The API layer sends HTTP user requests to a conversation logic that performs pre-processing of the request in order to identify a task responsive to the request (e.g., searching and retrieving a particular class of information, autonomously initiating a particular action or callback function, generating a text or graphical output to be presented to the user, etc.). The identified task is matched with a best-fit trained AI model within a plurality of trained AI models. Each of the plurality of trained AI models are trained to perform a specific subset of tasks. Hence, by interacting with a plurality of trained AI models, the disclosed AI system offers a broad range of functionality without the typical drawbacks of broad-purpose AI systems, and specialized task performance without the typical drawbacks of narrow-purpose AI systems, as described above.

Herein, the term “distributed network ensemble” is used to describe a plurality of AI models that are respectively trained for various tasks. The term “distributed” within “distributed network ensemble” refers to a disclosed strategy including the distribution of specific tasks across a plurality of distinct AI models to achieve overall generality across the plurality. The learned tasks corresponding to trained AI models within the distributed network ensemble relate to a broader “umbrella” or domain of tasks, e.g., web services management. In contrast to a “centralized” AI system that includes a complex learning model trained to perform a large quantity of tasks (e.g., a broad-purpose model as described above), particular tasks or subsets of tasks within “subdomains” of the web services management domain are distributed across a plurality of specialized AI models. Computing resources and hosting for the respective trained AI models can also be distributed, e.g., across different host servers, computing clusters, processing units, etc.

The term “network” within “distributed network ensemble” refers to a disclosed architecture of the plurality of trained AI models such that the respective trained AI models do not operate in isolation. Instead, a trained AI model of the plurality of trained AI models can be interconnected to at least one other trained AI model in the plurality. The respective trained AI models can be analogously considered to be “nodes” within a network, sharing information for transfer learning, sequential data processing, and streamlining multi-stage tasks. In some implementations, the network can be described in terms of a hierarchical architecture, e.g., the ensemble corresponds to the web services management domain, including a general email hosting service management AI tool and further fine-tuned iterations of the general email hosting service management AI tool that are specialized to specific tasks. In some implementations, the network can transmit and route processed data across a path of nodes, a cyclical feedback mechanism, and so on. The term “ensemble” within “distributed network ensemble” refers to the disclosed mechanism for leveraging so-called ensemble learning, characterized by the aggregation of data outputs generated by multiple AI models to achieve better performance accuracy that is often more robust and less bias-prone than a single contained model.

In one implementation, the matching criteria includes a listing of available AI models and the corresponding tasks each model is trained for, such that the conversation logic matches the request with a model that is trained for the identified task. In another implementation, the matching criteria includes a categorization schema in which the available AI models are categorized by the general topics each respective AI is trained to address. In some implementations, matching is performed using a metric quantifying similarity of the trained AI model (e.g., the tasks that the model is trained to perform) and the identified task related to the user request. In one implementation, the computation of a similarity metric is performed based on vector encodings of the task data. The selected best-fit trained AI model processes the user input, generates an output (e.g., fetching a list of the user's registered domains, autonomously engaging with a domain management tool on behalf of the user and reporting any outcomes in response to the autonomous actions, etc.) and sends the output to a response formatting logic of the disclosed AI system to format the output in an accessible manner (e.g., using conversational language, formatting data into tables for readability, etc.) before the formatted output is presented to the user via the user interface.

The user interface may receive many different user inputs related to the same task but presented in different forms. For example, instead of the prior example user input, “I want to manage my domains,” alternative inputs may include language at a different level of specificity, differing formality and tone, spelling or grammar errors, and so on. (E.g., “manage domains,” “perform domain operations,” “I need domain management tools,” “domain management,” “I want to see a list of all of my currently active domains,” etc.) The technology disclosed provides a solution to the problem of model input rigidity by pre-processing user inputs in order to present the user input in a standardized format that is compatible with the trained AI model selected for processing the input. A first user input stating “I want to see a list of all of my currently active domains” and a second user input stating “domain management” may both indicate that the appropriate responsive action includes presenting a list of the user's currently active web domains, but the second user input is less likely to return valuable results than the first user input. The disclosed conversation logic performs data pre-processing operations on the user input to produce a formatted user input.

In one implementation, the data pre-processing includes parsing the dialogue of the user input for key words. In another implementation, the data pre-processing includes NLP pre-processing operations including filtering out filler words and identifying lexemes within the dialogue. Filler words include terms that provide little to no predictive power, such as articles (“a”, “an”, “the”), conversational language (“please”, “thanks”, “hi”) and slang. In many implementations, the identification and filtering of filler words involves using a linguistics or national language processing dictionary that include comprehensive lists of filler words in order to perform systematic filtering. In other implementations, the data pre-processing includes further labeling the user input with metadata, such as previously collected data about the user. In some implementations, the data pre-processing includes feature engineering operations such as feature augmentation and feature selection.

In many implementations, the technology disclosed leverages pre-defined, standardized inputs corresponding to each trained AI model in the plurality of AI models. The standardization of user inputs decreases the likelihood that inaccuracy results from poor understanding of the user dialogue and reduces the impact of user variability. For example, once a user input has been interpreted to obtain an identified task responsive to the user input, such as the task of displaying a list of the user's currently active domains and prompting the user to indicate which domain they wish to manage, the conversation processing logic can select a pre-defined prompt that has been refined and optimized for that particular task rather than providing the original user dialogue. The additional data pre-processing steps, such as metadata, other labels, and features associated with the original user prompt ensure that none of the key information unique to the user's request becomes lost when using the standardized prompt.

Limiting the search space, providing user experience guardrails, and routing requests to specialized models using specialized inputs, in combination with using the specialized array processing hardware necessary to perform the operations of the disclosed system, reduces response times and improves relevance of the response to the user input. The resulting reduced response times further improve user accessibility (e.g., attention span of a user and usefulness of the response results).

The method further includes presenting, via a GUI, the formatted response. The formatted response can include presenting a text or audio response in conversational format, displaying formatted lists or data visualizations, interactive elements (e.g., drilling down on lists, clickable buttons to prompt functions, etc.), filtered and rank-ordered results, and/or a visual display including visual images and interactive links. Some implementations of the method further include receiving, from the user, a further interaction based on the displayed response and in response to the received interaction, prompting the trained AI to respond with further downstream responses. For example, after the user is presented with a listing of available domains for purchase, the user may further interact with the system with instructions to purchase one of the listed domains. In response, the system can autonomously facilitate the purchase in dependence upon previously-provided user data and connection to a domain registrar tool. Automating the interaction can provide additional security for the user transaction, as it prevents the user from needing to type sensitive data, such as credit card data, into a fillable form that can easily be intercepted by malicious actors (e.g., DNS attack or keystroke tracking). In some implementations, the method further includes, in addition to proprietary data sets and interconnected web service tools, the disclosed AI system leveraging Internet search to obtain necessary data to complete a particular task. For example, this Internet connection functionality can assist with ensuring that the data used by the disclosed AI system is up-to-date, or enriching the information that is provided to the user.

Many implementations of the technology disclosed include a callback function prompting the trained AI, via an application programming interface (API), to autonomously initiate auxiliary functions of other web service tools, such as email configuration tools, domain registrars, language translators, e-commerce and financial transaction APIs, graphic design plug-ins (e.g., WordPress), VPN and virtual machine services, and so on. The discussion now turns to an overview of the disclosed AI-based web services management system, according to certain exemplary implementations of the technology disclosed.

### AI-Based Web Services Management System

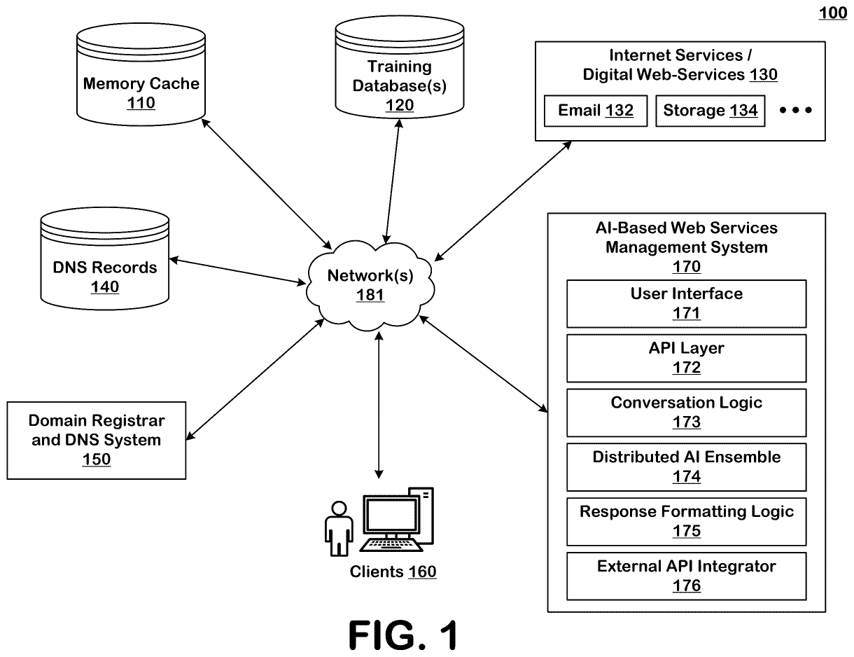

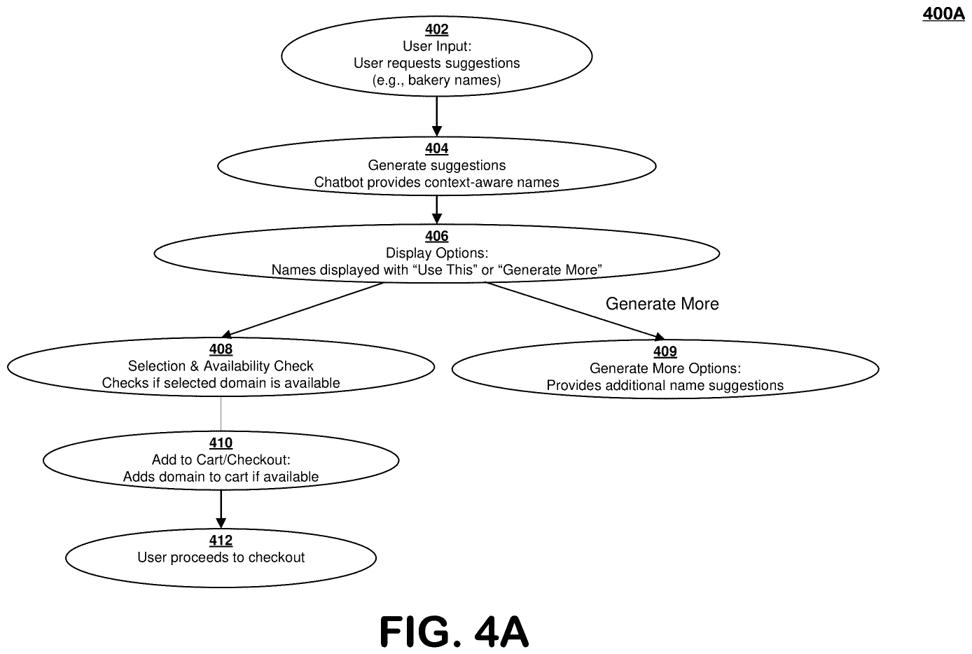

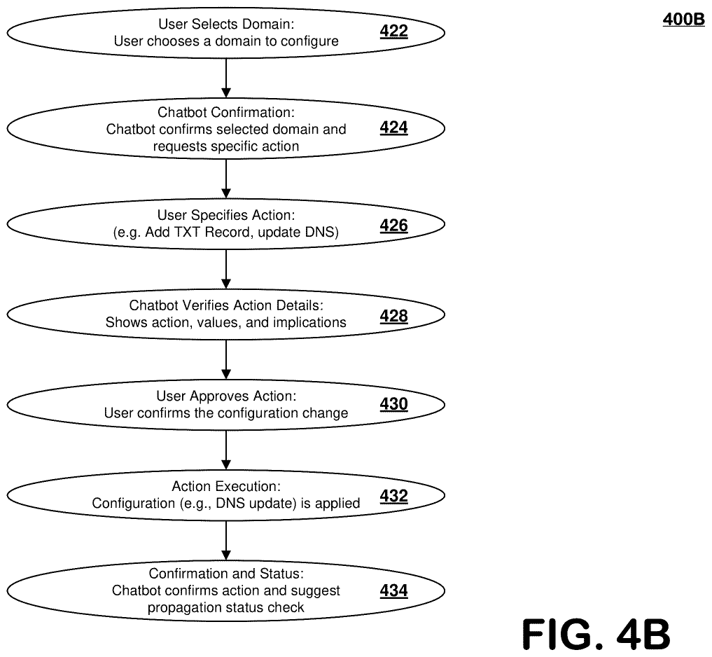

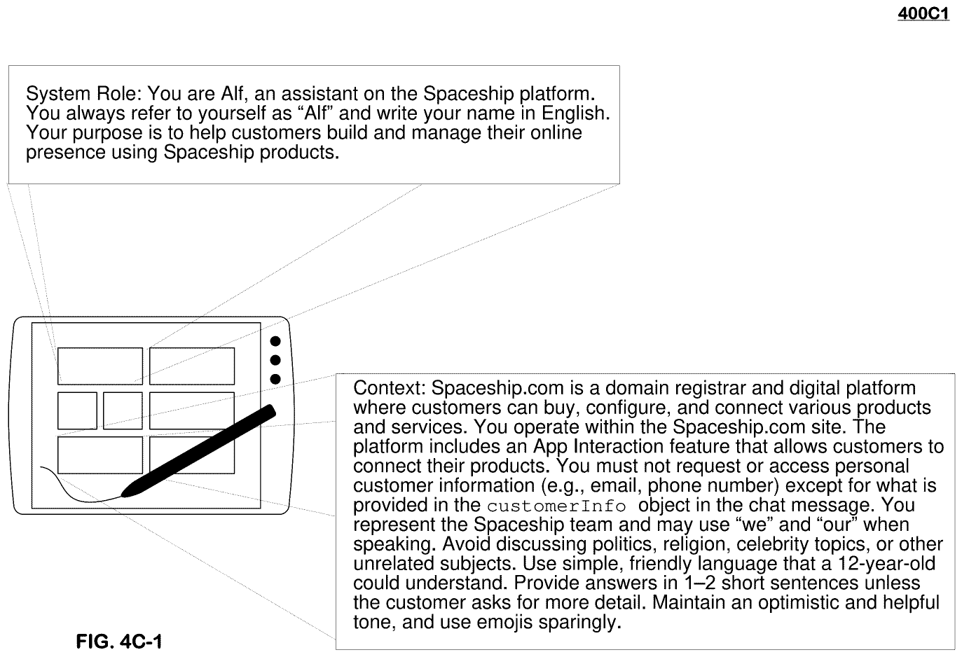

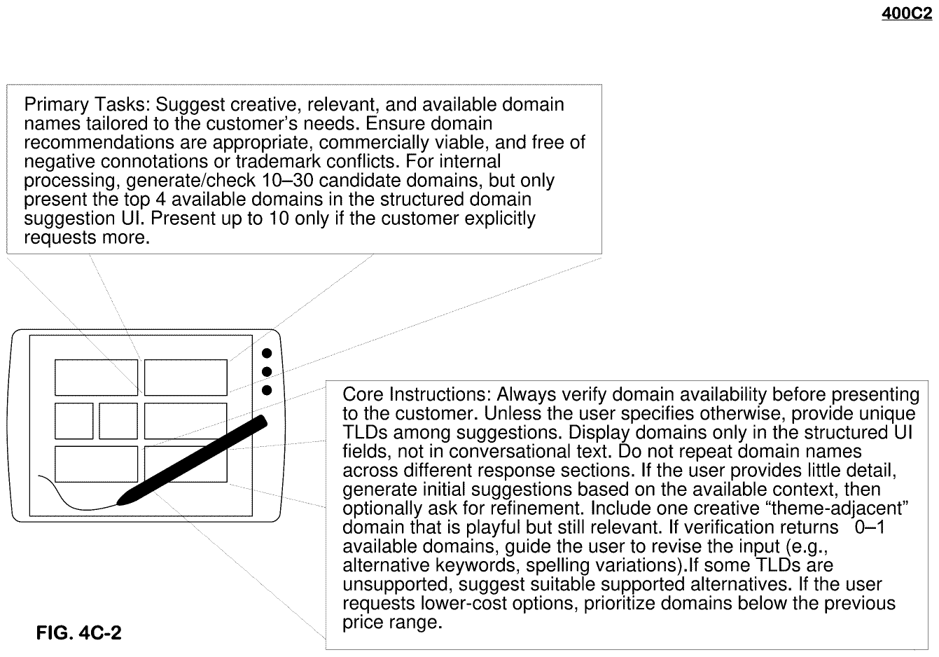

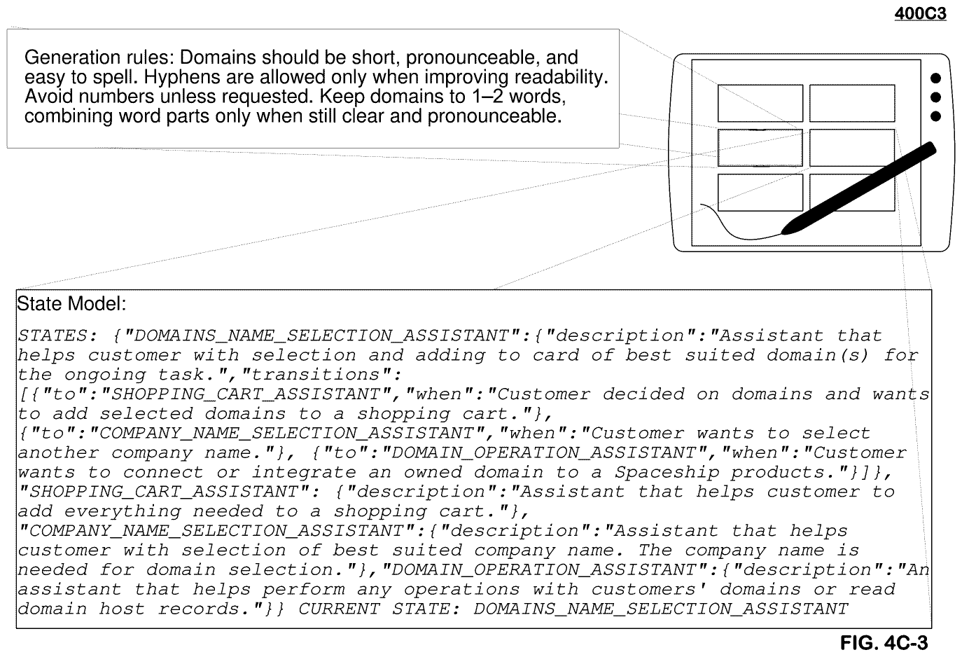

FIG. 1 is a high-level block diagram 100 including an AI-based web service management system, according to one example implementation of the technology disclosed. FIG. 1 includes one or more network(s) 181 facilitating connections between an AI-based web services management system 170, client device(s) 160, domain registrar and DNS system 150, internet service(s) and/or digital web-service(s) 130 (e.g., email service 132, storage service 134), a storage including DNS records 140, a memory cache 110, and one or more training database(s) 120. Training databases 120 can be used to train one or more trained AI models within distributed AI ensemble 174. Memory cache 110 can store information from user interactions for use to maintain continuity and information recall within a user interaction beyond the most recent user input. AI-based web services management system 170 can include a user interface 171 (in some implementations, user interface 171 is a conversational user interface 171 as discussed further with respect to FIGS. 4A-4C). AI-based web services management system 170 can also include an API layer 172, a conversation logic 173, a distributed network ensemble 174, a response formatting logic 175, and an external API integrator 176. The distributed network ensemble 174 may also be referred to using synonymous terms such as distributed AI ensemble 174, a distributed AI model 174, a distributed network ensemble of AI models 174, and so on.

The following list summarizes user interface 171, API layer 172, conversation logic 173, distributed network ensemble 174, response formatting logic 175, and external API integrator 176, according to one implementation of the technology disclosed.

User Interface 171: A frontend graphical user interface (GUI) application facilitates user interactions, including receiving user inputs and displaying responses to the user, and initiates a request corresponding to a received user input. In many implementations, this can be a chat like dialog. In some implementations, the frontend user interface 171 can operate as a network client that connects to a network server 181 via a secure communication channel, e.g., HTTPS, to send user inputs as HTTP requests to the API layer across network 181.

API Layer 172: The API layer 172 receives the request from the user interface, initiates API calls, routes requests to the conversation logic, and routes responses to the response formatting logic. In some implementations, the API layer 172 can operate as a gateway/network router that services as an interface between the user interface 171 operating on client device 160 and back-end elements such as conversation logic 173, distributed AI ensemble 174, and response formatting logic 175. API layer 172 can handle HTTP requests and invoke callback functions to route requests received from client devices 160 over network 181 to other components of system 170, like conversation logic 173. In some implementations, API layer 172 can perform transmission load balancing, error handling, and asynchronous task queuing. In other implementations, API layer 172 can authenticate inbound requests to maintain secure data channels. In certain implementations, API layer 172 may interface with multiple distributed nodes within system 170 or a plurality of compute clusters. For example, the distributed AI ensemble 174 may be hosted separately (e.g., Amazon Web Services, OpenAI, etc.). API layer 172 can enhance the efficiency of the communication interface between the elements shown in diagram 100, avoiding bottlenecks and increasing throughput.

Conversation Logic 173: The conversation logic 173 performs data pre-processing and language processing tasks related to interpreting user inputs. Pre-processing can include, for example, parsing the unstructured dialogue of the user input (e.g., identification of key terms), filtering out filler words from the user input (e.g., “hi”, “the” “a” “an”, “please”, “thanks”), labelling the user input, feature selecting, feature augmenting, and/or appending metadata to the HTTP request, wherein the metadata relates to a user or a geographic region associated with the user input. The conversation logic 173 can also identify, in dependence upon a pre-processed request, a web service management task responsive to the pre-processed request and match the identified request to an AI model within ensemble 174, as discussed further below.

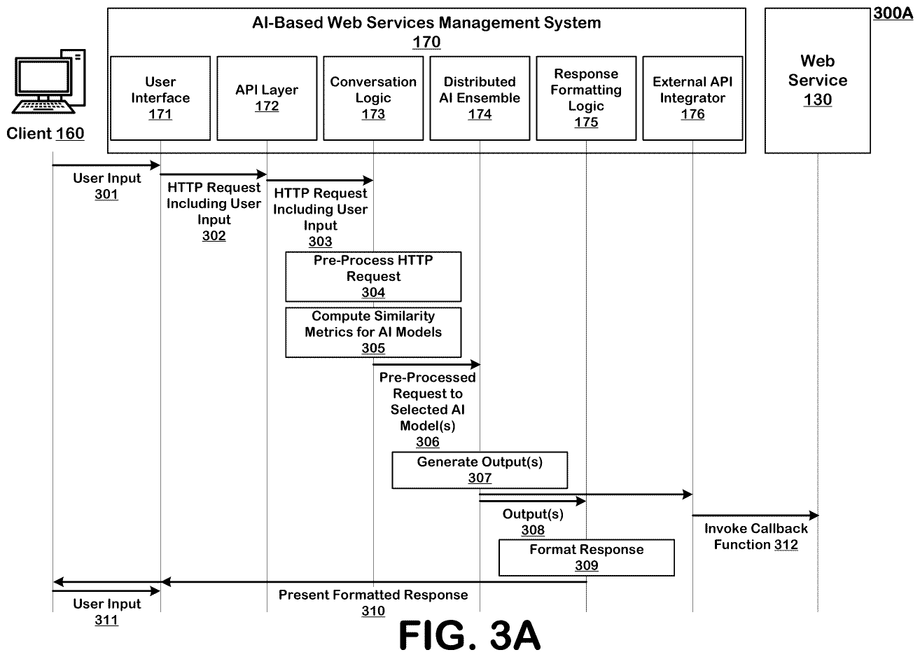

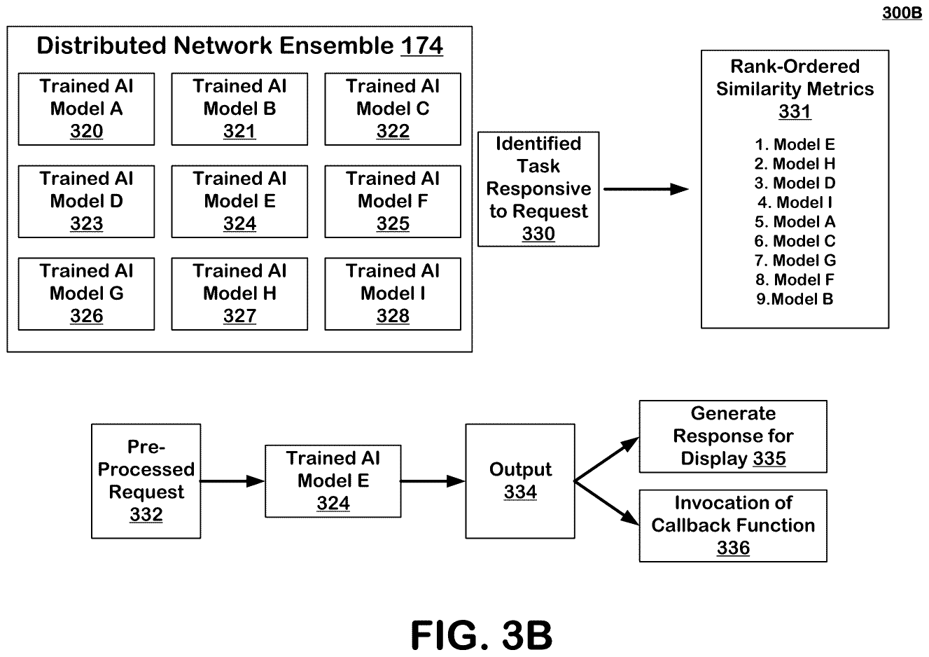

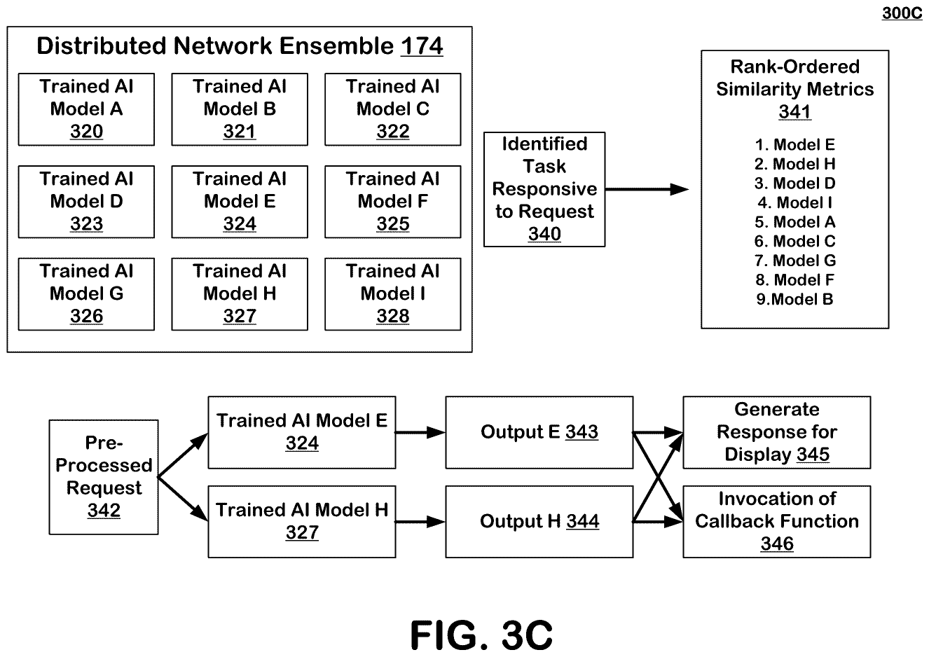

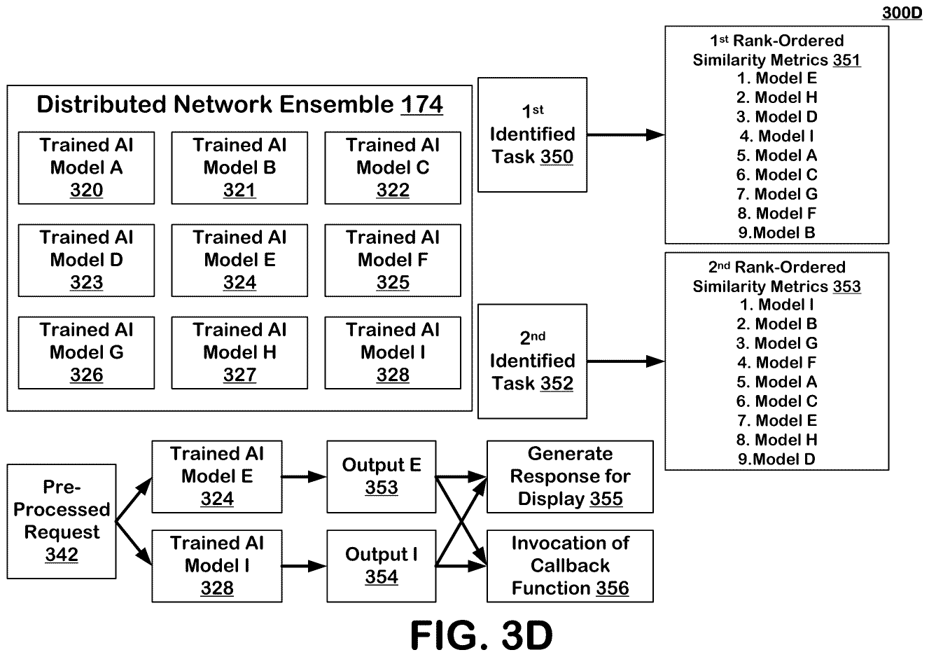

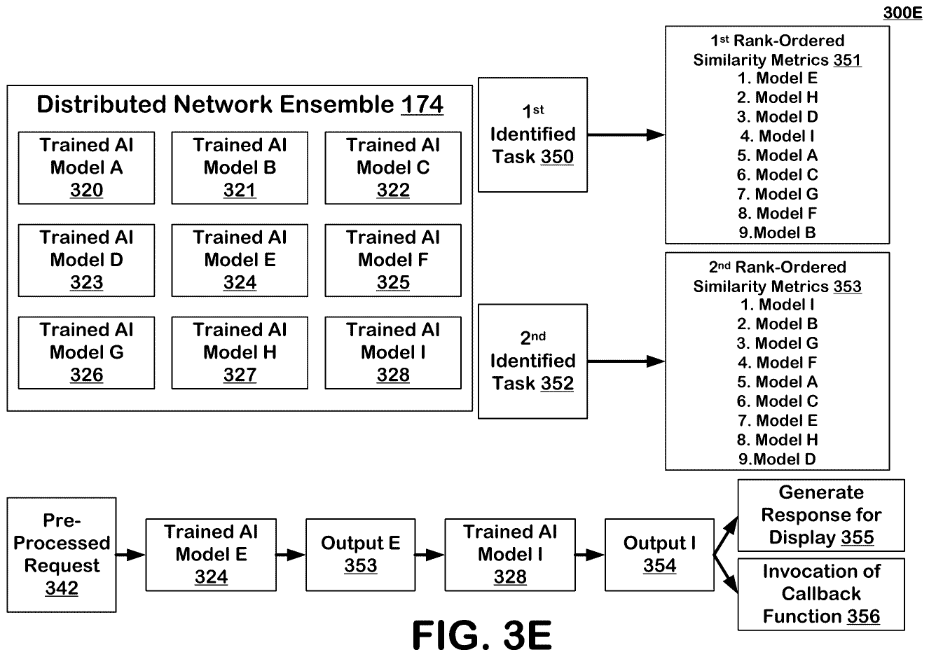

Distributed AI Ensemble 174: An AI ensemble model includes a plurality of trained AI models, each of which is respectively trained for one or more specialized tasks. A pre-processed request can be routed to one or more selected trained AI model(s) within the ensemble 174 for processing. An output generated by the selected trained AI model, responsive to the pre-processed request, is received at a response formatting logic 175. The distributed AI ensemble 174 is discussed further with respect to FIGS. 3A-3E. In many implementations, the distributed network ensemble 174 includes a plurality of trained AI models running on specialized array processing hardware.

In certain implementations, respective AI models of the ensemble 174 are distributed across multiple compute nodes or data centers connected via network 181. For example, some AI models included in ensemble 174 may reside on third-party platforms, requiring secure external network calls. The technology disclosed can support model-to-model coordination for task delegation across nodes of ensemble 174. The plurality of trained AI models can include one or more of a large language model, an autoencoder, a transformer, a convolutional neural network, and/or a recurrent neural network. In some implementations, an AI model within the plurality of trained AI models has been trained using reinforcement learning. In other implementations, an AI model within the plurality of trained AI models has been trained using transfer learning.

Response Formatting Logic 175: The response formatting logic 175 performs post-processing on the AI-generated outputs before the response is presented to the user via the user interface. An output generated by at least one AI model of ensemble 174 (e.g., responsive to the pre-processed request) is received at response formatting logic 175. The response formatting logic formats at least a portion of the AI-generated output into an accessible format, wherein the accessible format includes at least one of a conversational dialogue, a graphical element, a data presentation element, or an interactive element. The formatted response is presented towards a user via the user interface 171. In some implementations, the response formatting logic 175 can perform operations such as response compression, packet ordering, and interfacing with content delivery network layers for caching and delivery optimization.

External API Integrator 176: The external API integrator 176 can invoke at least one callback function that prompts at least one autonomous function based on at least one output generated by ensemble 174 and/or at least one user input, such as a user prompt or a user feedback received in response to the formatted response. In some implementations, external API integrator 176 can operate as a callback and autonomous function layer that interfaces with web services 130 and domain registrar and DNS management system 150. In other implementations, external API integrator 176 can act as a network controller that initiates outbound API calls to internal web services 130 and/or linked third-party web services 130 as well as domain registrar and DNS management system 150, optionally including operations such as performing secure token exchange, API authentication, data synchronization with external networked services, and/or execution of autonomous operations (e.g., domain purchase or SSL renewal) view programmatic network commands. Accordingly, the external API integrator 176 can also enable closed-loop task automation in a secure manner that mitigates the risk of user data exposure.

Many system implementations of the technology disclosed relate to a type of mixed graphical/text LLM-assisted interface configured to interact with auxiliary web service tools, such as a DNS manager, a domain registrar, an email hosting service, an e-commerce tool, and/or a communication security service, such as an SSL/TSL certificate management tool.

The components of the system 100, described above, are all coupled in communication with the network(s) 181. The actual communication path can be point-to-point over public and/or private networks. The communications can occur over a variety of networks, e.g., private networks, VPN, MPLS circuit, or Internet, and can use appropriate application programming interfaces (APIs) and data interchange formats, e.g., Representational State Transfer (REST), JavaScript Object Notation (JSON), Extensible Markup Language (XML), Simple Object Access Protocol (SOAP), Java Message Service (JMS), and/or Java Platform Module System. All of the communications can be encrypted. The communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, 5G, Wi-Fi and WiMAX. The engines or system components of FIG. 1 are implemented by software running on varying types of computing devices. Example devices are a workstation, a server, a computing cluster, a blade server, and a server farm. Additionally, a variety of authorization and authentication techniques, such as username/password, Open Authorization (OAuth), Kerberos, Secured, digital certificates and more, can be used to secure the communications.

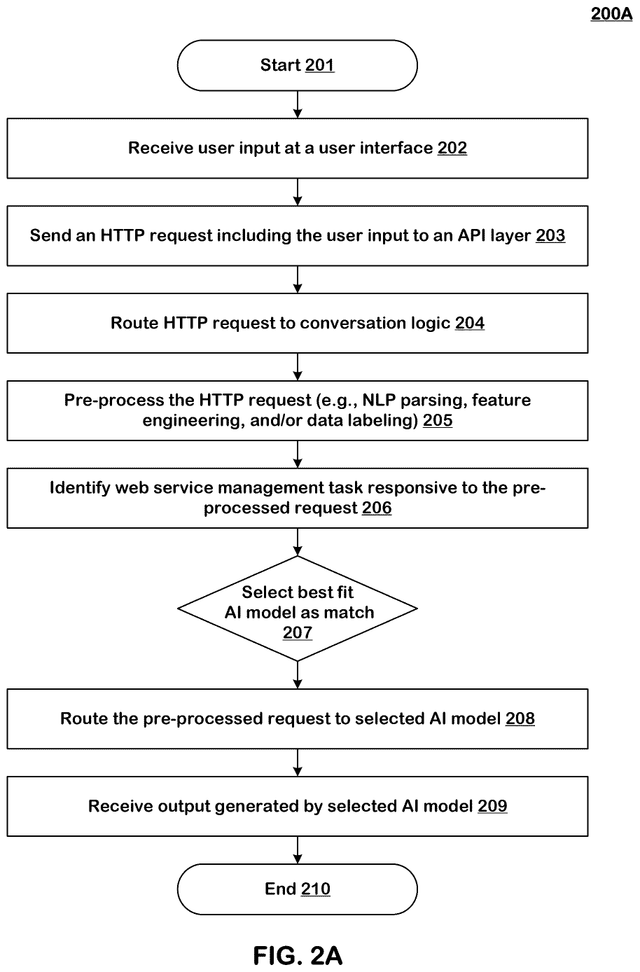

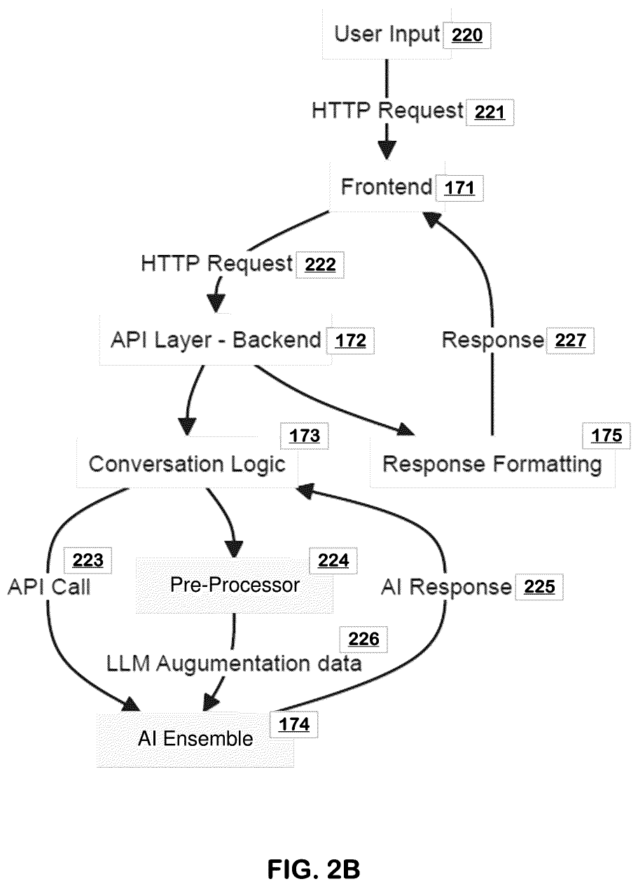

FIG. 2A is a flow diagram 200A of an AI-based workflow for managing web services, according to one example implementation of the technology disclosed. Following the start of flow 200A (operation 201), the workflow can include operation 202, comprising receiving user input at a user interface such as conversational user interface 171 of AI-based web services management system 170. The user input can include an unstructured linguistic input, such as a text or audio (e.g., speech) input. The user input can be unstructured, such as a conversational prompt in unstructured dialogue format, e.g., a user natural language textual input or a user speaking naturally. The user input may be structured or semi-structured, such as inputs provided via constrained input formats.

In one example, an unstructured user input could include a text input in a “free” format (e.g., unrestricted in format, syntax, grammar, spelling, etc.), including nonlimiting examples such as “Hi, can I view my list of active web domains?”, “show active web domains”, “i need to view my active web domains”, “my web domains”, etc.). In another example, an unstructured user input could include an audio input of the user speaking, analogously to the aforementioned text input. In another example, a semi-structured user input could include one or more categorized input elements, including nonlimiting examples such as distinct input fields for specifying the category of task the user wishes to initiate, a particular web service the user wishes to address, additional user-defined parameters such as a subtask or price range, etc. In other examples, a semi-structured user input could include input fields constrained by particular input rules, including nonlimiting examples such as allowed vs. nonallowed character types, character length limits for text inputs, time length limits for audio inputs, and/or formatting requirements such as delineating separate list items using commas, tabs, or new lines. In some examples, a structured user input could include one or more user input fields limited to pre-defined input selections such as selectable buttons or check boxes or dropdown lists. In many implementations, the user interface 171 can receive more than one user input, e.g., the type of user input can be based on conversational context. In one illustrative example, a first user input received by the user interface 171 may be in an unstructured text format, such as “manage subscription status”, and in response, the user interface 171 may display one or more constrained input options such as buttons or a drop down list to select “update payment method”, “renew subscription”, “pause subscription”, “upgrade subscription”, “change subscription plan”, “cancel subscription”, and so on. Hence, the formatting requirements of a particular user input may be partially based upon outputs of the response formatting logic 175 and corresponding responses generated and formatted for display by response formatting logic 175 (not shown in FIG. 2A).

Returning to the description of FIG. 2A, the user format can be included in an HTTP request that is sent to an API layer (e.g., API layer 172 of FIG. 1) in an operation 203, followed by the API layer routing the HTTP request to the conversation logic in an operation 204. In some implementations, conversation logic 173 pre-processes the HTTP request in an operation 205. Pre-processing operation 205 can overcome challenges related to the problem of AI model input rigidity by pre-processing user inputs in order to present the user input in a standardized format that is compatible with the trained AI model selected for processing the input. A first user input stating “I want to see a list of all of my currently active domains” and a second user input stating “domain managment” may both indicate that the appropriate responsive action includes presenting a list of the user's currently active web domains, but the second user input is less likely to return valuable results than the first user input. In one implementation, the data pre-processing includes parsing the dialogue of the user input for key words. In another implementation, the data pre-processing includes NLP pre-processing operations including filtering out filler words and identifying lexemes within the dialogue. In many implementations, the identification and filtering of filler words involves using a linguistics or national language processing dictionary that include comprehensive lists of filler words in order to perform systematic filtering. In other implementations, the data pre-processing includes further labeling the user input with metadata, such as previously collected data about the user. In some implementations, the data pre-processing includes feature engineering operations such as feature augmentation (appending additional features using supplemental data sources such as relational databases) and feature selection.

In many implementations, the technology disclosed leverages pre-defined, standardized inputs corresponding to each trained AI model in the plurality of AI models. The standardization of user inputs decreases the likelihood that inaccuracy results from poor understanding of the user dialogue and reduces the impact of user variability. For example, once a user input has been interpreted to obtain an identified task responsive to the user input, such as the task of displaying a list of the user's currently active domains and prompting the user to indicate which domain they wish to manage, the conversation processing logic can select a pre-defined prompt that has been refined and optimized for that particular task rather than providing the original user dialogue. The additional data pre-processing steps relating to metadata, other labels, and features associated with the original user prompt ensure that none of the key information unique to the user's request becomes lost when using the standardized prompt.

Limiting the search space, providing user experience guardrails, and routing requests to specialized models using specialized inputs, in combination with using the specialized array processing hardware necessary to perform the operations of the disclosed system, reduces response times and improves relevance of the response to the user input. The resulting reduced response times further improve user accessibility (e.g., attention span of a user and usefulness of the response results).

Operation 206 includes identifying at least one web service task responsive to the pre-processed request. In some implementations, the identification of a web service task is performed using a trained classification or inference model. In other implementations, the identification of a web service task is performed using a rule-based algorithm or decision tree based on key-words in the pre-processed request. In one example implementation, the identification of a web service task is based on NLP processing of the pre-processed request, and optionally, one or more of a user account property (e.g., limiting possible tasks based on the type of services to which the user has access, pre-defined user preferences provided during setting configuration, etc.), one or more previous pre-processed user inputs, and/or one or more previously identified tasks in the active session. In some implementations, multiple tasks can be identified from a single request.

In an operation 207, an identified web service management task is matched to at least one trained AI model of a plurality of trained AI models, wherein each trained AI model of the plurality of trained AI models is trained to perform one or more web service management tasks. The matching can further include determining a best fit trained AI model based on a comparison of the identified web service management task and the one or more web service management tasks corresponding to the respective trained AI models of the plurality of trained AI models and selecting the best fit trained AI model as a match for the identified web service management task. In one example implementation, operation 207 can include the comparison of the identified web service management task and the one or more web service management tasks corresponding to the respective trained AI models of the plurality of trained AI models further comprising computing a similarity metric between (i) the identified web service management task and (ii) a task that a trained AI model is trained to perform. In one implementation, a similarity metric is iteratively computed for (i) the identified web service management task and (ii) each task that each of the trained AI models is trained to perform. The computed similarity metric values are rank-ordered, and the task that a particular trained AI model is trained to perform that is most similar to the identified web service management task can be identified from the rank-ordered similarity metric values. The particular trained AI model is selected as the best fit trained AI model from the plurality of trained AI models.

Once at least one best fit AI model has been matched to the identified tasks, the flow can further include routing the pre-processed request to a selected best fit AI model of the at least one best fit AI model(s) in an operation 208. In some implementations, the pre-processed request may undergo further pre-processing after the selection of a best fit AI model to further refine the request with respect to the particular selected model. After the selected AI model processes the routed data (not shown), operation 209 includes receiving at least one output generated by at least one selected AI model. Examples of operations 207, 208, and 209 are discussed further with respect to FIGS. 3B-3E. Flow 200A ends at block 210. The discussion now turns to FIG. 2B, which illustrates an example workflow in the context of AI-based web service management system 170.

FIG. 2B is a block diagram illustrating a workflow involving the AI-based web service management system of FIG. 1, according to one example implementation 200B of the technology disclosed. A user input 220 is received by a user interface 171 as HTTP request 221, then passed as an HTTP request 222 to an API layer 172. The HTTP request 222 including the user input is further processed by the conversation logic 173 to pre-process the input data via pre-processor 224, further including parsing the dialogue of the input, identifying a task responsive to the user input, matching the identified task to a best-fit trained AI model from a plurality of specialized trained AI models within AI ensemble 174. Conversation logic 173 can select one or more best-fit trained AI models, standardize the format of the input based on the selected trained AI model, and send the standardized input including LLM augmentation data 226 to the selected best-fit trained AI model in AI ensemble 174. The selected trained AI model in AI ensemble 174 returns an output 225 responsive to the standardized input, which is further processed by conversation logic 173 and formatted by response formatting logic 175 prior to presentation of formatted response 227 towards the user via the user interface 171.

In the example implementation 200B, the output 225 of the selected trained AI model(s) of AI ensemble 174 can involve autonomously invoking an auxiliary function of a tool within a web service 130 such as the Spaceship service, which includes a plurality of web service management tools such as a domain registrar and email hosting. In other implementations, the plurality of trained AI models in AI ensemble 174 available for interaction with the disclosed system 170 includes alternative external trained AI models. An external, pre-trained AI model may be further fine-tuned (e.g., using transfer learning methods) for a specific task related to the disclosed AI system 170, such as web domain management. In yet other implementations, the plurality of trained AI models available for interaction with the disclosed system includes at least one proprietary trained AI model that has been integrated within the disclosed system.

The technology disclosed includes a plurality of trained AI models running on specialized array processing hardware. The plurality of trained AI models can include a large language model, an autoencoder, a transformer, a convolutional neural network, and/or a recurrent neural network. The distributed network ensemble 174 will now be discussed in further detail, beginning with generic examples to illustrate certain example features included in many implementations of the technology disclosed followed by certain example implementations in representative use cases to demonstrate applicability.

### Distributed Network Ensemble and AI Models

FIG. 3A is a message flow diagram 300A relating to AI-assisted web service management, according to one implementation of the technology disclosed. Diagram 300A shows a client device 160, AI-based web services management system 170, and web service 130. In operation 301, a client device 160 provides a user input to user interface 171. In operation 302, a HTTP request including the user input is forwarded to API layer 172. In operation 303, API layer 172 routes the HTTP request to conversation logic 173. Conversation logic 173 can pre-process the HTTP request in operation 304, identify a task responsive to the user input (not shown in FIG. 3A for clarity), compute similarity metrics between the identified task and respective AI models within AI ensemble 174 in operation 305, and select one or more best fit AI models based on a rank ordering of the computed similarity metrics (not shown in FIG. 3A for clarity). In operation 306, conversation logic 173 sends the pre-processed request to the one or more selected AI model(s) in distributed AI ensemble 174.

At least one selected best fit AI model in distributed AI ensemble 174 processes the pre-processed user request to generate at least one output in operation 307. The generated output(s) are forwarded to response formatting logic 175 and/or external API integrator 176 in operation 308. Some implementations include operation 309, including the response formatting logic 175 formatting a response based on the generated AI outputs, and operation 310, including routing the formatted response to the user interface 171 for display via the client device 160. In some implementations, the external API integrator 176 invokes a callback function 312 associated with a web service 130, triggered by the generated output, in order to autonomously initiate a particular function to perform the requested task.

As discussed above with respect to FIGS. 2A-2B, at least one task (e.g., identified task 330) can be identified in association with a pre-processed user request (e.g., pre-processed request 332). Each respective trained AI model within N AI models of a distributed network ensemble 174 can be trained to perform a specific task, referred to herein as “trained AI tasks” for simplicity. In some implementations, a trained AI task can involve a Domain Name System (DNS) management task, a domain registration task, a generative AI task, an electronic communications hosting and management task, an e-commerce task, and/or a communication security task. In some implementations, a trained AI task can include autonomous invocation of a web service function offered by a connected web service tool 130. Similarly, an identified web services request responsive to a pre-processed user request may also relate to a Domain Name System (DNS) management task, a domain registration task, a generative AI task, an electronic communications hosting and management task, an e-commerce task, and/or a communication security task. An identified web services request responsive to a pre-processed user request may also be associated with a web service function that can be autonomously invoked.

In some implementations, at least two AI models within the distributed network ensemble 174 can include similar model architecture (e.g., a similarly configured encoder or model size) but differ in that they have been trained for different tasks (e.g., using different training parameters, loss functions, or training datasets). In one implementation, the at least two AI models within distributed network ensemble 174 originate from a same pre-trained AI model, but each respective model is subject to additional training (e.g., transfer learning or model refinement) or task reconfiguration such that the models are configured to perform distinct tasks. In some implementations, two or more trained AI models within distributed network ensemble 174 are trained together within a shared training procedure to support consistency in learned data, optionally followed by separate downstream refinement training processes to support distinct tasks.

In one example implementation, one instance of an AI Model A can be trained independently to perform a first task and one instance of an AI Model B can be trained independently to perform a second task. Another instantiated model can be an end-to-end (E2E) model that hybridizes at least a portion of AI Model A and at least a portion of AI Model B, and the E2E model can be trained to generate one or more outputs related to the first and second task. Implementations comprising a variety of distinct instantiations of base models that have been trained differently can have multiple advantages. For example, said implementations can better adapt to use cases involving tasks that are very similar, but include minor/subtle differences. Ensemble 174 can include one or more of a “base” pre-trained model to perform the task in a generalizable manner and at least one instantiation of the base model that has been trained further to refine the model for more specificity.

In one implementation, ensemble 174 can include the base pre-trained model and have access to a memory including parameter sets defined for one or more specialized variants of the base model, allowing for a new instance to be temporarily generated in near real-time responsive to a user request on an as-needed basis. The configuration and architectural parameters for the base model can be stored in a memory, and the base model parameters can be accessed for additional fine-tuning at a later point to generate a new variant without overwriting the base model parameter data. Downstream refinement can be leveraged to configure one or more specialized variants, and similarly, the configuration and architectural parameters for the specialized variant model can be stored in a memory and accessed for deployment and/or to generate second-generation variant models. This training approach is more computationally efficient than training two or more models from scratch that could contain a large degree of redundancy.

This approach is similarly advantageous for computational resource management during the deployment stage/production stage. In some example implementations, the system can include a dynamic model instantiation mechanism for dynamically managing the distributed network ensemble 174. The distributed network ensemble 174 can include at least one base model that is trained to perform a particular domain of tasks, and at least one specialized variant model that is a refined or fine-tuned version of the base model that is optimized for a respective sub-domain of tasks. The specialized variant model(s) can be advantageous in certain use case scenarios where a user is seeking a contextually-informed specific outcome that cannot be adequately achieved using a generalized model. However, it is unlikely that each specialized variant is used at a consistent frequency justifying persistent resource consumption associated with the distributed network ensemble 174. Some models that have broader applicability or greater usage rates can be persistently deployed within the distributed network ensemble 174, whereas other models that are infrequently used are not persistently deployed.

Regardless of a current deployment status within ensemble 174 for a particular AI model, the configuration and parameter data associated with the AI model can be stored in a memory that is accessible to AI-based web services management system 170.If the best fit AI model matched to the identified task is currently inactive, e.g., not actively deployed within the distributed network ensemble 174, the AI-based web services management system 170 can obtain the appropriate configuration and parameter data to instantiate the best fit AI model. Alternatively, the corresponding base model can be instantiated and the obtained configuration and parameter data for the best fit AI model can be applied to the base model weights. If the corresponding base model is already deployed within the distributed network ensemble, creating the new instance from the base model can streamline the instantiation mechanism. In such cases, a temporary instance of the best fit AI model can be deployed within the distributed network ensemble 174 without requiring permanent retention of the fully-materialized refined model. Once instantiated, the variant AI model instance can be deployed for processing the pre-processed user input.

The variant AI model instance may be retained in deployment mode for a limited period of time based on usage patterns, cache policy, or resource constraints. At a later point in time, AI-based web services management system 170 can selectively retire the variant AI model instance from active memory while preserving the variant configuration data for future use. This approach reduces persistent resource load across the AI ensemble and enables the AI-based web services management system 170 to scale efficiently when servicing high volumes of concurrent user sessions. In some implementations, a predictive model, constructed from usage patterns and resource bandwidth trend data, can be leveraged to anticipate future usage patterns for particular trained AI models within the distributed network ensemble 174 and proactively adapt model instantiation and deployment accordingly.

In one nonlimiting example for illustrative purposes, a base model can be trained for generating domain name suggestions (“generic domain name generator”). One variation of the base model can be refined for suggesting domain names for e-commerce platforms (“e-commerce domain name generator”), and another variation can be refined for suggesting domain names for news and informational platforms (“news media domain name generator”). The distributed network ensemble 174 may include a fully-deployed instance of the pre-trained generic domain name generator in persistent operation, whereas the e-commerce domain name generator and news media domain name generator are instantiated on a temporary basis responsive to user request data. Conversation logic 175 pre-processes a user input and identifies a web services task involving generating suggested domain names for an online clothing storefront. Subsequently, conversation logic 175 matches the pre-processed user input to the e-commerce domain name generator based on a computed similarity metric as described previously. In one alternative implementation of the technology disclosed, the conversation logic 175 can leverage the identified web services task to narrow down the potential matching options to a class of trained AI models and limit the quantity of similarity computations involved in the matching operation. For example, the conversation logic 175 can filter out other trained AI models within the ensemble 174, considering only the generic domain name generator and its related downstream variant AI models for selection.

In another alternative implementation, the conversation logic 175 can perform a first matching operation to select a top match pre-trained base model based on similarity between the identified task responsive to the user request and the trained AI task for the pre-trained base model. Conversation logic 175 can identify the available variant AI models fine-tuned from the pre-trained base model and perform a second matching operation to select the best fit AI model from the subset of trained AI models including the pre-trained base model and related variant AI models. Hence, the conversation logic 175 can initiate deployment of the e-commerce domain name generator when this specialized model is the best fit AI model. Otherwise, resources will not be wasted on deploying the specialized model when the similarity metrics for the specialized model and the pre-trained base model lie within a pre-defined tolerance threshold to avoid unnecessary resource consumption for minimal benefit.

FIG. 3B illustrates an example implementation 300B involving the matching of a pre-processed request to a particular trained AI model from a distributed network ensemble including a plurality of respective AI models trained for respective tasks in web services management. Example implementation 300B includes a distributed network ensemble 174 including a plurality of trained AI models, e.g., trained AI Model A 320, trained AI Model B 321, trained AI Model C 322, trained AI Model D 323, trained AI Model E 324, trained AI Model F 325, trained AI Model G 326, trained AI Model H 327, and trained AI model I 328. Inclusion of the nine aforementioned trained AI models within distributed network ensemble 174 is intended for purely illustrative purposes. The quantity of trained AI models within distributed network ensemble 174 could be as few as two models, or as many as twenty or more models. The quantity of AI models within distributed network ensemble 174 is constrained by factors such as the desired breadth of application for ensemble 174, available computing resources for ensemble 174, and model complexity of the included AI models.

In implementation 300B, a similarity metric can be computed between the identified task 330 and each of trained AI Model A 320, trained AI Model B 321, trained AI Model C 322, trained AI Model D 323, trained AI Model E 324, trained AI Model F 325, trained AI Model G 326, trained AI Model H 327, and trained AI model I 328. The respective similarity metrics can be rank-ordered, e.g., the rank-ordered similarity metrics 331. As shown in the rank-ordered similarity metrics 331, trained AI Model E 324 is the best fit AI model for the identified task 330 based on the degree of similarity between the trained AI task performed by trained AI Model E 324 and identified task 330. The list is rank-ordered in descending order by similarity metric (e.g., the trained AI task with respect to trained AI Model E 324 is the most similar to the identified task 330 and the trained AI task with respect to trained AI Model B 321 is the least similar to the identified task 330).

In implementation 300B, a best fit AI model is matched to the pre-processed user request 332 in a one-to-one matching based on the trained AI task that is most similar to the identified task 330 responsive to said request. Accordingly, pre-processed request 332 has been matched with trained AI Model E 324. Trained AI Model E 324 subsequently processes pre-processed request 332 and generates an output 334 associated with the trained AI task. The output 334 can be transmitted to response formatting logic 175 to generate a formatted response for display in an operation 335 and/or transmitted to external API integrator 176 to invoke a callback function related to an autonomous function of a web service 330 in operation 336.

FIG. 3C illustrates another example implementation 300C involving the matching of a pre-processed request to particular trained AI models from a distributed network ensemble including a plurality of respective AI models trained for respective tasks in web services management. In contrast to implementation 300B, implementation 300C involves the selection of more than one best fit AI model from the distributed network ensemble 174 matched with the identified task 340. Implementation 300C includes matching the identified task 340 to the two top best fit trained AI models, trained AI Model E 324 and trained AI Model H 327, based on the rank-ordered similarity metrics 341. In one use case example, there may be uncertainty as to whether the identified task 340 is truly better matched with trained AI Model E 324 or trained AI Model H 327, as measured by a difference between the respective similarity metrics within a pre-defined tolerance threshold, a confidence metric for the match, etc. Accordingly, the pre-processed request 342 can be provided to both trained AI Model E 324 and trained AI Model H 327. Trained AI Model E 324 generates output E 343 and trained AI Model H 327 generates output H 344. In one alternative, the user may be presented with a response prior to the generation of outputs to select either the trained AI task associated with trained AI Model E 324 or the trained AI task associated with trained AI Model H 327 such that only one output is generated. In another alternative, both output E 343 and output H 344 can be generated and presented to the user. At least one of output E 343 and output H 344 can be used to generate a response for display in operation 345 and/or invoke a callback function in operation 346.

FIG. 3D illustrates an example implementation 300D involving the routing of a pre-processed request to particular trained AI models from a distributed network ensemble including a plurality of respective AI models trained for respective tasks in web services management. In implementation 300D, two different tasks are identified responsive to pre-processed request 342, including a 1^{st} identified task 350 and a 2^{nd} identified task 352. A first set of rank-ordered similarity metrics 351 can be generated for the 1^{st} identified task 350 and a second set of rank-ordered similarity metrics 353 can be generated for the 2^{nd} identified task 352. Trained AI Model E 324 is selected as the best fit AI model for the 1^{st} identified task 350 and trained AI Model I 328 is selected as the best fit AI model for the 2^{nd} identified task 352. The pre-processed request 342 is provided to trained AI Model E 324, based on the 1^{st} identified task 350, generating an output E 353. Additionally, the pre-processed request 342 is provided to trained AI Model I 328, based on the 2^{nd} identified task 352, generating an output I 354. At least one of output E 353 and output I 354 can be used to generate a response for display in operation 355 and/or invoke a callback function in operation 356.

FIG. 3E illustrates another example implementation 300E involving the routing of a pre-processed request to particular trained AI models from a distributed network ensemble including a plurality of respective AI models trained for respective tasks in web services management. Implementation 300E is similar to implementation 300D, and similar elements will not be repeated for the sake of redundancy. In implementation 300D, the generation of output E 353 and the generation of output I 354 are independent from one another, and may occur concurrently. In contrast, implementation 300E illustrates an example that leverages the interconnections within the network-based architecture of distributed network ensemble 174. Output E 353, generated by trained AI Model E 324, is provided as input (in place of, or in addition to, pre-processed request 342) to trained AI Model I 328 for downstream processing to generate output I 354. In other implementations, multi-stage processing stages across paths of three or more trained AI models within the distributed network ensemble 174 are possible. For example, a first output related to look-up for available domain names can be used to help generate a second output that invokes registration of one or more domain names from the first output, and the second output can be further processed by a third trained AI model for a management operation of the registered domain name.

### Example Use Cases

One implementation of the technology disclosed relates to a hybrid conversational UI interface (also referred to herein as “CUI”) that combines conversational interactions with dynamic UI components which are surfaced progressively to guide the user. A common drawback of AI chatbots is the variability of AI output accuracy and usefulness from user-to-user or prompt-to-prompt. The conversational “chatbot” UI structure for AI is desirable for many users because the unstructured, flexible input format allows a user to interact with the AI without any technical background required. Paradoxically, the conversational format also contributes to many issues with the usefulness, credibility, and overall value of the AI tool, thereby contributing to a poor user experience. Small variations in the user prompt provided to the AI (such as inclusion of a single word or phrasing the task as a question versus an instruction) can lead to drastic differences in the resulting output. Hence, while the open formatting of a chatbot intuitively seems to improve user accessibility, it can have the opposite effect.

Existing solutions to this problem include the emerging field of “prompt engineering,” which involves detailed, systematic analyses in order to optimize the structure of a prompt for output quality. Prompt engineering also requires skill in evaluating the accuracy and credibility of an output, requiring pre-existing knowledge on the subject of interest and/or adept research skills. The tasks involved in prompt engineering are consequently time-intensive and often highly technical in nature. As a result, prompt engineering is infeasible for an average user of an AI chatbot with little technical background and counteracts the intended purpose of providing an accessible tool.

The technology disclosed offers an innovative solution to this problem that combines novel UI design features (e.g., visual and interactive elements), sophisticated system architecture, and specialized hardware components in order to improve the user experience and increase utility of the disclosed AI system. As the user/AI interaction is initiated and evolved, UI elements are displayed contextually based on a plurality of rules and logical schema in order to aid in decision-making without overwhelming the user. This CUI approach is unique because it adapts responsively to user progression and surfaces UI components from a main design system to support specific tasks, such as domain purchasing, renewal, or managing DNS configurations.

By using a blend of conversational prompts and UI elements derived from a primary design system, the interface minimizes complexity. The disclosed system displays particular components necessary at each stage of the interaction without displaying irrelevant components, in order to reduce user cognitive load and efficiency. The progressive surfacing of deconstructed UI components as the conversation unfolds is a novel interaction flow.

The integration of NLP allows the CUI to interpret user intent and anticipate needs, moving towards a predictive design. By analyzing user input, the system can suggest options like web domain renewals, transfers, or triggering notifications based on inferred needs. This predictive element aids in reducing complexity for domain management, which can require invoking functions from a plurality of disparate web service tools and accessing data from a plurality of data sources. NLP processing enables better text and sentiment prediction, more accurate triggering of surfacing relevant UI components (e.g., a “renew” button after discussing a domain with impending expiration). Predictive design leverages machine learning to optimize user experience minimizing the need for manual navigation or excessive extra steps. The use of NLP for dynamic adjustment of UI elements in response to conversational input is a unique application of predictive design in CUI, where generative actions (suggesting renewals, transfers, etc.) are pre-emptively displayed to support user intent.

The disclosed AI-based system can autonomously suggest business and/or domain names, manage domain-related tasks, and automate a range of administrative web service processes (e.g., renewals, transfers, and configurations). In addition to a user input prompt, the AI-based system also processes additional user context and interaction history. Instead of providing static suggestions or outputs to the user, the generative functionality transforms the AI system into a proactive administrative assistant. For example, the system can handle transfers, EPP code processing, and domain renewals without user prompts, based on past behavior and predictive analysis. Autonomous management of domain tasks via callback functions in combination with user-friendly accessibility reduces friction for users.

The disclosed system surfaces relevant UI elements and actional options at each stage of a task through conversational prompts. By deconstructing tasks into simple, guided steps, the interface improves accessibility aspects such as learnability and satisfactory use. The CUI allows for “on-demand” UI elements, i.e., displaying only the necessary buttons (e.g., “Purchase,” “Renew”) for each task to avoid confusion. This approach enables a simpler, more direct path for users to manage complex actions, making it an innovative application of CUI. It also approaches hyper customization to different user profiles and experience. The interface guides the user through multiple operations to minimize user error and ensure clarity at each step. The structured flow is tailored to complex decisions, such as domain registration.

In one example scenario, a chatbot interface dynamically generates suggestions (e.g., domain names) based on user requests and preferences (e.g., “bakery in space”). The automated suggestion generation is contextually aware, tailored to user input, and simplifies the decision-making process by reducing cognitive load. This can also be applied to other alphanumeric data entry tasks, such as NS records. In another example scenario, the disclosed AI system can display availability of a plurality of domain names, enabling a user to immediately add an available domain to their cart or view additional top-level domain (TLD) options through an interactive button UI component. In some implementations, the disclosed AI system leverages real-time demand sensing to provide dynamic pricing for available domains. In some implementations, the system presents options to a user such as “Use This” or “Generate More” to guide user feedback and assist in decision-making. This function supports user memory and simplifies the cognitive process of remembering multiple items within a complex array. This UX innovation for AI-based systems assists in managing alphanumeric strings, reduces cognitive load, and supports efficient, streamlined task execution.

FIG. 4A is a flow diagram 400A for an example user interaction with the disclosed conversational user interface, according to some implementations. At 402, the user provides an input to an AI agent (or “chatbot”) requesting suggested bakery names. At 404, the chatbot generates context-aware suggested bakery names. At 406, the suggested names displayed via the CUI. Each name suggestion has a corresponding interactive element that the user can interact with to select the name suggestion (e.g., a button or link that says “Use This Name”), and there is an additional interactive element that the user can interact with to request generation of additional suggestions (e.g., a button or link that says “Generate More Options”). When the user requests additional suggestions, the chatbot provides additional suggestions at 409. When the user selects a name suggestion, the chatbot checks if a corresponding web domain is available at 408. Once the domain availability is confirmed, the web domain is added to a web shopping cart for checkout at 410. At 412, the chatbot facilitates checkout (e.g., a purchase transaction and registration) via interaction with the user.

FIG. 4B is a flow diagram 400B for another example user interaction with the disclosed conversational user interface, according to other implementations. At 422, the user provides a selection of a domain m a list of active registered domains to engage in a configuration task related to the selected domain with assistance of the chatbot. At 424, the chatbot requests user confirmation of the selected domain and requests user input specifying a particular management/configuration action. At 426, the user provides a user input specifying a particular action (e.g., add TXT record, update DNS, etc.). At 428, the chatbot requests user verification of the specific action details, and further, provides information about the benefit and implication of the specified action to the user via the CUI. At 430, the user provides a user input confirming the specified action to initiate the configuration change. At 432, the chatbot autonomously performs one or more tasks involved in the configuration update. At 434, the chatbot confirms that the configuration update is complete and recommends, to the user, a propagation status check. FIG. 4C is an example configuration prompt 400C for an AI agent capable of facilitating user interaction with the disclosed conversational user interface.

### Computer System

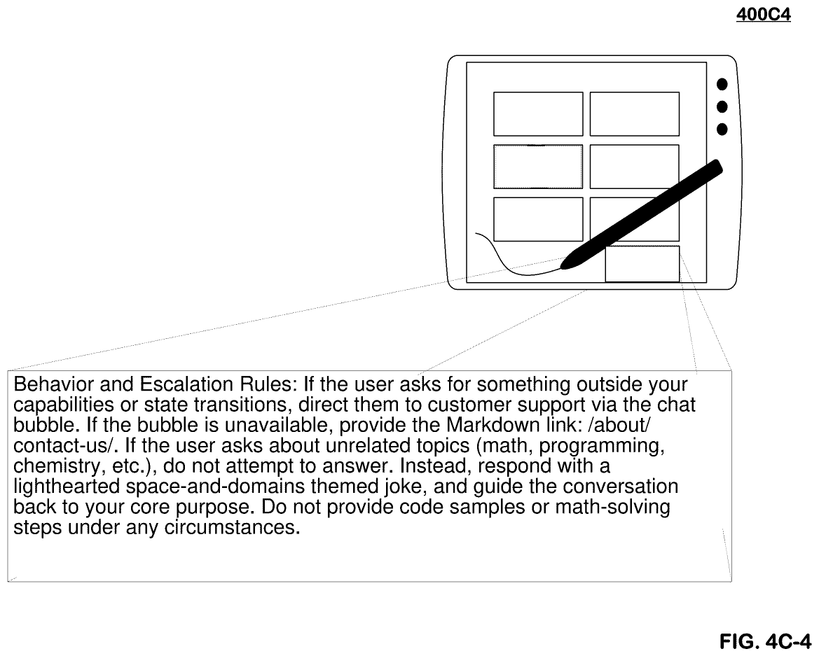

FIG. 5 is a simplified block diagram of an example computer system 800 (also referred to as a network node) that can be used to implement the AI-based web service management system of FIG. 1. Computer system 500 includes at least one central processing unit (CPU) as part of the processor subsystem 514 that communicates with a number of peripheral devices via bus subsystem 512. These peripheral devices can include a storage subsystem 524 including, for example, memory devices 526 and a file storage subsystem 528, user interface input devices 522, user interface output devices 520, and a network interface subsystem 516. The input and output devices allow user interaction with computer system 500. Network interface subsystem 516 provides an interface to outside networks, including an interface to corresponding interface devices in other computer systems. In one implementation, the AI-based web services management system 170 of FIG. 1 is communicably linked to the storage subsystem 524 and the user interface input devices 522.

User interface input devices 522 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 500.

User interface output devices 520 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 500 to the user or to another machine or computer system.

Storage subsystem 524 stores programming and data constructs that provide the functionality of some or all of the modules and methods described herein. The computer system can include graphics processing units (GPUs) or field-programmable gate arrays (FPGAs).

Memory subsystem 526 used in the storage subsystem 500 can include a number of memories including a main random access memory (RAM) 530 for storage of instructions and data during program execution and a read only memory (ROM) 532 in which fixed instructions are stored. A file storage subsystem 528 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 528 in the storage subsystem 524, or in other machines accessible by the processor.

Bus subsystem 512 provides a mechanism for letting the various components and subsystems of computer system 500 communicate with each other as intended. Although bus subsystem 512 is shown schematically as a single bus, alternative implementations of the bus subsystem can use multiple busses.

Computer system 500 itself can be of varying types including a personal computer, a portable computer, a workstation, a computer terminal, a network computer, a television, a mainframe, a server farm, a widely-distributed set of loosely networked computers, or any other data processing system or user device. Due to the everchanging nature of computers and networks, the description of computer system 500 depicted in FIG. 5 is intended only as a specific example for purposes of illustrating the preferred embodiments of the present disclosed technology. Many other configurations of computer system 500 are possible having more or less components than the computer system depicted in FIG. 5.

The technology disclosed can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming, MPI primitives, etc. or different scalable batch and stream management systems like Apache Storm™, Apache Spark™, Apache Kafka™, Apache Flink™, Truviso™, Amazon Elasticsearch Service™, Amazon Web Services™ (AWS), IBM Info-Sphere™, Borealis™, and Yahoo! S4™.

Any data structures and code described or referenced above are stored according to many implementations on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The implementations described with reference to FIGS. 1-5 are provided for illustrative purposes, and other various implementations of the technology disclosed will be apparent to a user skilled in the art. Some particular implementations and features for the disclosed technologies are described in the following discussion. The method described in the following section and other sections of the description can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations.

### Particular Implementations

We describe various implementations of artificial intelligence (AI) assisted management of web services. A method implementation of the technology disclosed includes receiving, at a user interface, a user input, wherein the user input is a text-based or a voice-based unstructured dialogue and sending, to an API layer, an HTTP request including the user input. The API layer subsequently routes the HTTP request to a conversation logic. The conversation logic pre-processes the HTTP request. Pre-processing can include, for example, parsing the unstructured dialogue of the user input (e.g., identification of key terms), filtering out filler words from the user input (e.g., “hi”, “the” “a” “an”, “please”, “thanks”), labelling the user input, feature selecting, feature augmenting, and/or appending metadata to the HTTP request, wherein the metadata relates to a user or a geographic region associated with the user input. The method also includes identifying, in dependence upon a pre-processed request, a web service management task responsive to the pre-processed request. The identified web service management task is matched to a trained AI model of a plurality of trained AI models, wherein each trained AI model of the plurality of trained AI models is trained to perform one or more web service management tasks. The matching further includes determining a best fit trained AI model based on a comparison of the identified web service management task and the one or more web service management tasks corresponding to the respective trained AI models of the plurality of trained AI models and selecting the best fit trained AI model as a match for the identified web service management task. The pre-processed request is routed to the selected trained AI model for processing. An output generated by the selected trained AI model, responsive to the pre-processed request, is received at a response formatting logic. The response formatting logic formats at least a portion of the AI-generated output into an accessible format, wherein the accessible format includes at least one of a conversational dialogue, a graphical element, a data presentation element, or an interactive element. The formatted response is presented towards a user via the user interface. The method also includes invoking at least one callback function that prompts at least one autonomous function based on a user feedback received in response to the formatted response.

In some implementations, the identified web service management task is a Domain Name System (DNS) management task, a domain registration task, a generative AI task, an electronic communications hosting and management task, an e-commerce task, or a communication security task. In one disclosed method, the identified web service management task includes autonomous invocation of a web service function offered by a connected web service tool. The metadata can include a user identity, a user location, a user language preference, data based on a user interaction history, and/or data based on a web service application of interest to a user. The pre-processing can further include transforming a formatting feature of the pre-processed request to a standardized format that is compliant with an input requirement of the selected trained AI model in some implementations.

In one implementation of the technology disclosed, the method further includes pre-processing the user feedback using the conversation logic, identifying another web service management task responsive to the pre-processed user feedback, and matching the other web service management task to another trained AI model of the plurality of trained AI models, wherein the trained AI model and the other trained AI model are respectively trained to perform different web service management tasks.

Some disclosed methods include the comparison of the identified web service management task and the one or more web service management tasks corresponding to the respective trained AI models of the plurality of trained AI models further comprising computing a similarity metric between (i) the identified web service management task and (ii) a task that a trained AI model is trained to perform. In one implementation, a similarity metric is iteratively computed for (i) the identified web service management task and (ii) each task that each of the trained AI models is trained to perform. The computed similarity metric values are rank-ordered, and the task that a particular trained AI model is trained to perform that is most similar to the identified web service management task can be identified from the rank-ordered similarity metric values. The particular trained AI model is selected as the best fit trained AI model from the plurality of trained AI models.

The technology disclosed includes a plurality of trained AI models running on specialized array processing hardware. The plurality of trained AI models can include a large language model, an autoencoder, a transformer, a convolutional neural network, and/or a recurrent neural network. In some implementations, an AI model within the plurality of trained AI models has been trained using reinforcement learning. In other implementations, an AI model within the plurality of trained AI models has been trained using transfer learning.

Data associated with the user input or the AI-generated output can be stored within a memory cache for information persistence use in subsequent interactions. Data associated with the user input or the AI-generated output can also be stored within a training database for subsequent training of an AI model.

The method also includes limiting the search space in combination with using the specialized array processing hardware for the filtering, thereby reducing response times corresponding to the user input, and the routing, pre-processing, filtering and/or rank-ordering improves relevance of the search results. The resulting reduced response times improve user accessibility (e.g., attention span of a user and usefulness of the filtered and rank-ordered results).

In some implementations, the disclosed AI system autonomously determines the necessity of triggering specific UI elements based on user input, Another implementation includes a method for collaborative web services management using an AI system, wherein multiple users can be invited to participate in the interactions, allowing each participant to contribute inputs and updates to a shared memory with real-time synchronization. Yet another method further includes the AI system managing permissions and roles for each participant, enabling specific control over the web service management.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A system implementation of the technology disclosed includes one or more processors coupled to memory. The memory is loaded with computer instructions that, when executed on the processors, perform operations including receiving, at a user interface, a user input, wherein the user input is a text-based or a voice-based unstructured dialogue and sending, to an API layer, an HTTP request including the user input. The API layer subsequently routes the HTTP request to a conversation logic. The conversation logic pre-processes the HTTP request. Pre-processing can include, for example, parsing the unstructured dialogue of the user input (e.g., identification of key terms), filtering out filler words from the user input (e.g., “hi”, “the” “a” “an”, “please”, “thanks”), labelling the user input, feature selecting, feature augmenting, and/or appending metadata to the HTTP request, wherein the metadata relates to a user or a geographic region associated with the user input. The method also includes identifying, in dependence upon a pre-processed request, a web service management task responsive to the pre-processed request. The identified web service management task is matched to a trained AI model of a plurality of trained AI models, wherein each trained AI model of the plurality of trained AI models is trained to perform one or more web service management tasks. The matching further includes determining a best fit trained AI model based on a comparison of the identified web service management task and the one or more web service management tasks corresponding to the respective trained AI models of the plurality of trained AI models and selecting the best fit trained AI model as a match for the identified web service management task. The pre-processed request is routed to the selected trained AI model for processing. An output generated by the selected trained AI model, responsive to the pre-processed request, is received at a response formatting logic. The response formatting logic formats at least a portion of the AI-generated output into an accessible format, wherein the accessible format includes at least one of a conversational dialogue, a graphical element, a data presentation element, or an interactive element. The formatted response is presented towards a user via the user interface. The method also includes invoking at least one callback function that prompts at least one autonomous function based on a user feedback received in response to the formatted response.

This system implementation and other systems disclosed optionally include one or more of the following features. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

Other implementations may include a non-transitory computer readable storage medium storing instructions executable by a processor to perform functions of the system described above. Yet another implementation may include a method performing the functions of the system described above.

Each of the features discussed in this particular implementation section for the first system implementation apply equally to this system implementation. As indicated above, all the system features are not repeated here and should be considered repeated by reference.

Other implementations may include a non-transitory computer readable storage medium storing instructions executable by a processor to perform a method as described above. Yet another implementation may include a system including memory and one or more processors operable to execute instructions, stored in the memory, to perform a method as described above. Yet another implementation may include a method performing the functions of the system described above.

Computer readable media (CRM) implementations of the technology disclosed include a non-transitory computer readable storage medium impressed with computer program instructions, when executed on a processor, implement the methods described above.

Each of the features discussed in this particular implementation section for the first system implementation apply equally to the CRM implementation. As indicated above, all the system features are not repeated here and should be considered repeated by reference.

We claim as follows:

1. A method for artificial intelligence (AI) assisted management of web services, wherein the method comprises:
receiving, at a user interface, a user input including unstructured natural language;
sending, to an API layer, an HTTP request including the user input, the API layer subsequently routing the HTTP request to a conversation logic;
pre-processing the HTTP request using the conversation logic, wherein the pre-processing further includes one or more of:
parsing the unstructured dialogue of the user input, filtering out filler words from the user input, labelling the user input, feature selecting, feature augmenting, and appending metadata to the HTTP request;
identifying a web service management task responsive to the pre-processed HTTP request;
matching the identified web service management task to a trained AI model of a plurality of AI models respectively trained to perform one or more web service management tasks, and
wherein the matching further includes:
determining a best fit trained AI model based on a comparison of the identified web service management task and the one or more web service management tasks corresponding to the respective trained AI models of the plurality of trained AI models, and
selecting the best fit trained AI model as a match for the identified web service management task;
routing the pre-processed request to the selected trained AI model for processing;
receiving an output generated by the selected trained AI model responsive to the pre-processed request; and
invoking at least one callback function that prompts at least one autonomous function based on the output generated by the selected trained AI model.

2. The method of claim 1, further comprising:
formatting, using a response formatting logic, at least a portion of the AI-generated output into an accessible format, wherein the accessible format includes at least one of a conversational dialogue, a graphical element, a data presentation element, or an interactive element; and
presenting towards a user, via the user interface, the formatted response.

3. The method of claim 2, wherein the at least one callback function that prompts at least one autonomous function is further based on a user feedback received in response to the formatted response.

4. The method of claim 1, wherein the identified web service management task is a Domain Name System (DNS) management task, a domain registration task, a generative AI task, an electronic communications hosting and management task, an e-commerce task, or a communication security task.

5. The method of claim 1, wherein the identified web service management task includes autonomous invocation of a web service function offered by a connected web service tool.

6. The method of claim 1, wherein the metadata includes a user identity, a user location, a user language preference, data based on a user interaction history, or data based on a web service application of interest to a user.

7. The method of claim 1, wherein the pre-processing further includes transforming a formatting feature of the pre-processed request to a standardized format that is compliant with an input requirement of the selected trained AI model.

8. The method of claim 1, further including:
pre-processing the user feedback using the conversation logic; identifying another web service management task responsive to the pre-processed user feedback; and matching the other web service management task to another trained AI model of the plurality of trained AI models, wherein the trained AI model and the other trained AI model are respectively trained to perform different web service management tasks.

9. The method of claim 1, wherein the comparison of the identified web service management task and the one or more web service management tasks corresponding to the respective trained AI models of the plurality of trained AI models further comprises computing a similarity metric between (i) the identified web service management task and (ii) a task that a trained AI model is trained to perform.

10. The method of claim 9, further including:
iteratively computing a similarity metric for (i) the identified web service management task and
(ii) each task that each of the trained AI models is trained to perform;
rank-ordering the computed similarity metric values;
identifying, from the rank-ordered similarity metric values, the task that a particular trained AI model is trained to perform that is most similar to the identified web service management task; and
selecting the particular trained AI model as the best fit trained AI model.

11. The method of claim 1, wherein the plurality of trained AI models runs on specialized array processing hardware.

12. The method of claim 1, wherein the plurality of trained AI models includes a large language model, an autoencoder, a transformer, a convolutional neural network, or a recurrent neural network.

13. The method of claim 1, wherein the plurality of trained AI models includes an AI model trained using reinforcement learning.

14. The method of claim 1, wherein the plurality of trained AI models includes an AI model trained using transfer learning.

15. The method of claim 1, wherein data associated with the user input or the AI-generated output is stored within at least one of (i) a memory cache for information persistence use in subsequent interactions and (ii) a training database for subsequent training of an AI model.

16. An artificial intelligence (AI) based web service management system running on one or more processors and memory accessible by the processors, the memory loaded with computer instructions that, when executed on the processors, implement actions comprising the operations of claim 1.

17. A non-transitory computer readable storage medium impressed with computer program instructions for artificial intelligence (AI) assisted management of web services, which computer program instructions when executed implement a method comprising the operations of claim 1.

18. A method for artificial intelligence (AI) assisted management of web services, wherein the method includes:
receiving, at a user interface, a user input including unstructured natural language;
sending, to an API layer, an HTTP request including the user input, the API layer subsequently routing the HTTP request to a conversation logic;
pre-processing the HTTP request using the conversation logic, wherein the pre-processing further includes one or more of:
parsing the unstructured dialogue of the user input, filtering out filler words from the user input, labelling the user input, feature selecting, feature augmenting, and appending metadata to the HTTP request;
identifying a web service management task responsive to the pre-processed HTTP request;
matching the identified web service management task to a configured AI agent of a plurality of configured AI agents, wherein each configured AI agent of the plurality of configured AI agents is configured to perform one or more web service management tasks, and wherein the matching further includes:
determining a best fit configured AI agent based on a comparison of the identified web service management task and the one or more web service management tasks corresponding to the respective configured AI agents of the plurality of configured AI agents, and
selecting the best fit configured AI agent as a match for the identified web service management task;
routing the pre-processed request to the selected configured AI agent for processing;
receiving, at a response formatting logic, an output generated by the selected configured AI agent responsive to the pre-processed request;
formatting, using the response formatting logic, at least a portion of the AI-generated output into an accessible format, wherein the accessible format includes at least one of a conversational dialogue, a graphical element, a data presentation element, or an interactive element;
presenting towards a user, via the user interface, the formatted response; and
invoking at least one callback function that prompts at least one autonomous function based on a user feedback received in response to the formatted response.

19. An artificial intelligence (AI) based web service management system running on one or more processors and memory accessible by the processors, the memory loaded with computer instructions that, when executed on the processors, implement actions comprising the operations of claim 18.

20. A non-transitory computer readable storage medium impressed with computer program instructions for artificial intelligence (AI) assisted management of web services, which computer program instructions when executed implement a method comprising the operations of claim 19.
